(19) United States
(12) Patent Application Publication
(10) Pub. No.: US 2025/0301333 A1
(43) Pub. Date: Sep. 25, 2025

(54) SELF-HEALING BACKHAUL CHANNEL FOR INTEGRATED ACCESS BACKHAUL (IAB)

(71) Applicant: Intel Corporation, Santa Clara, CA (US)

(72) Inventors: Stephen T. Palermo, Chandler, AZ (US); Shrikant M. Shah, Chandler, AZ (US); Parker Lischwe, Phoenix, AZ (US)

(21) Appl. No.: 19/233,627

(22) Filed: Jun. 10, 2025

Related U.S. Application Data
(60) Provisional application No. 63/659,238, filed on Jun. 12, 2024.

(51) Int. Cl. H04W 16/18; H04L 5/00

(52) U.S. Cl. CPC H04W 16/18; H04L 5/0048

(57) ABSTRACT

Various approaches for the deployment and coordination of network operation processing, compute processing, and communications, for Integrated Access Backhaul (IAB) networks coordinated with Artificial Intelligence (AI) model data processing, are discussed. An example method for operating an adaptive backhaul channel includes: establishing a wireless backhaul connection to communicate data between an IAB Donor and an IAB Node; performing channel sounding, via the control channel, to exchange reference signals that provide feedback for a state of the wireless backhaul connection; evaluating results from the channel sounding with a trained AI model to determine at least one identified change to the wireless backhaul connection; and updating at least one characteristic of the wireless backhaul connection, based on the at least one identified change.

### BACKGROUND

Various approaches are being investigated for 5G New Radio (5G NR) backhaul, including ways to deliver sufficient high capacity backhaul related to small cells. 5G NR gNBs require backhaul in the Gbps, as backhaul is established from the gNB or cell tower toward the 5G core network (CN). Some implementations to remote locations have proposed use of fiber, point-to-point microwave, even satellite backhaul in order to connect additional nodes.

5G promises network densification, and 5G NR includes more bands than previous wireless network standards to transmit data. However, higher bandwidth (especially mmWave) propagation causes higher path loss, so more 5G deployments have led to the need for more Base Station (BS) units operating as gNBs. A BS may be connected to the 5G CN through a physical media connection (e.g., wired or fiber); however, not all BSs can be reached with physical media connections because of location and trenching costs, or because the BSs will be located in remote or temporary areas.

Based on these and other real-world constraints, the 3rd Generation Partnership Project (3GPP) has proposed the use of wireless Integrated Access and Backhaul (IAB) via nodes that use wireless backhaul instead of fiber. Some implementations of IAB, for example, use the same access frequencies (e.g., FR1/FR2 frequencies) for wireless backhaul to connect BSs. 3GPP, in Release 18, has also introduced the concept of mobile integrated access and backhaul (mIAB) nodes, to enable the use of IAB nodes for a Radio Access Network (RAN) on-demand at mobile locations.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an overview of network connectivity using Integrated Access and Backhaul (IAB) nodes and donors, according to an example.

FIG. 2 depicts an architecture corresponding to the use of IAB Nodes and IAB Donors, according to an example.

FIG. 3 depicts an architecture for implementing artificial intelligence (AI) inferencing operations on an IAB Node and an IAB Donor, according to an example.

FIGS. 4A to 4C depict flowcharts of operations for applying AI modeling and adjustments in a 5G RAN with an IAB Node and IAB Donor, according to an example.

FIG. 5 depicts a block diagram of statistic collection operations in an O-RAN architecture supporting an IAB Node and IAB Donor, according to an example.

FIGS. 6A and 6B depict flowcharts of approaches for applying AI modeling and adjustments in a 5G RAN with an IAB Node and IAB Donor, according to an example.

FIG. 7 depicts results of inferencing on an IAB Node and an IAB Donor, according to an example.

FIG. 8 depicts an example of a RAN configuration between an IAB Donor and an IAB Node, according to an example.

FIG. 9 depicts an approach for using Artificial Intelligence directed at the collection of data and measurements for an AI Training and Learning functional framework, according to an example.

FIG. 10 depicts further scenarios of IAB Nodes for 5G connectivity, according to an example.

FIG. 11 depicts a flowchart of a method for operating an adaptive backhaul channel for use in an IAB deployment, according to an example.

FIG. 12 depicts an overview of an edge cloud configuration for edge computing, according to an example.

FIG. 13 depicts an overview of layers of distributed compute deployed among an edge computing system, according to an example.

FIG. 14 depicts operational layers among endpoints, an edge cloud, and cloud computing environments, according to an example.

FIG. 15 depicts an example approach for networking and services in an edge computing system, according to an example.

FIG. 16A depicts an overview of example components deployed at a compute node system, according to an example.

FIG. 16B depicts a further overview of example components within a computing device, according to an example.

FIG. 17 depicts a software distribution platform to distribute software instructions and derivatives, according to an example.

### DETAILED DESCRIPTION

The following discusses technical challenges encountered with existing 5G New Radio (5G NR) communications technologies. The following further provides approaches for ensuring backhaul RAN channel integrity for developing 5G/6G RAN deployments, especially in evolved Network Topologies that include Integrated Access and Backhaul (IAB). Specifically, this disclosure applies to 5G/5G Mobile communications extending into new radio (NR) network topologies including IAB radio relay topologies that rely on service level agreements (SLAs) and other performance objectives between RAN Donor and RAN Node(s) to interconnect and transport data. IAB RAN Nodes can either be fixed or mobile—moving toward or away from a RAN Donor—requiring frequent adjustments not only to accommodate different RAN physical locations but also to avoid interference.

This disclosure introduces aspects of Artificial Intelligence (AI) models operating on an IAB RAN Node/Donor to select and maintain Backhaul Link SLA assurance by using channel sounding. This is accompanied by a monitored and self-healing “Backhaul Channel” that can support IAB or any other relevant backhaul traffic scheme. In one example, the following introduces an implementation of one of the backhaul channels as an “AI Priority Backhaul Channel” (AI-BLC) among the backhaul channels within the backhaul link. The AI-BLC is prioritized below the Backhaul Link Signaling Radio Bearer and above the User and Control Plane Backhaul Channels.

An AI-BLC can be used, among other use cases, to support near-real-time cascading AI inference decisions and actions that may originate at an IAB RAN Node but require additional AI inference computations at the IAB RAN Donor. For instance, the AI-BLC can be created, monitored, and prioritized to backhaul Node data for IAB Donor inference if some condition occurs, such as if the AI inference confidence is low on the IAB Node. The prioritized AI-BLC can be established as a dedicated channel to backhaul IAB Node traffic used to enable simultaneous or rapid AI object detection, tracking, and classification on both the IAB Node and the IAB Donor. Such computations may be performed at the IAB Donor for more accurate results to support improved yet real-time decisions/classifications.

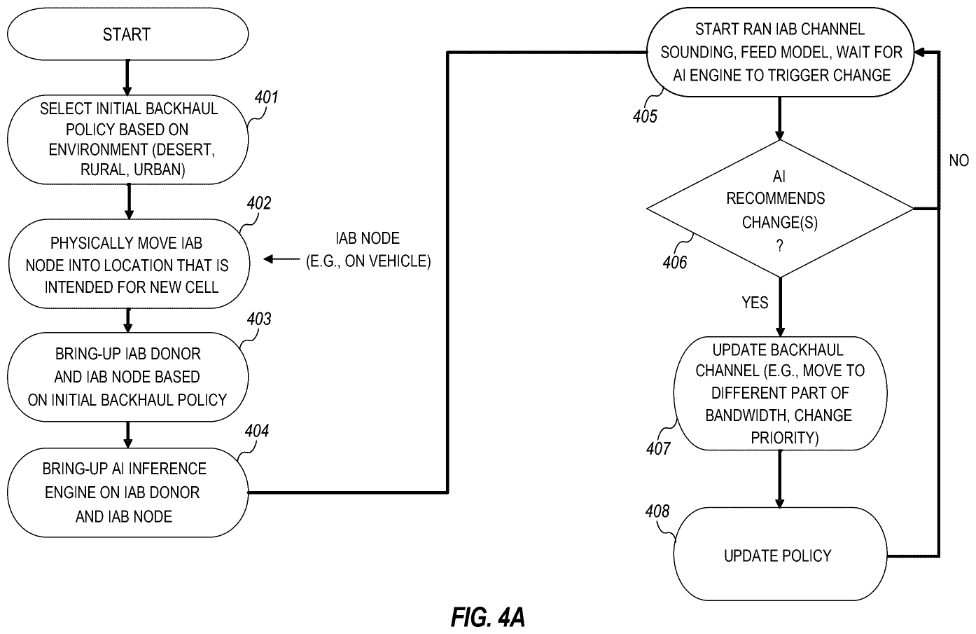

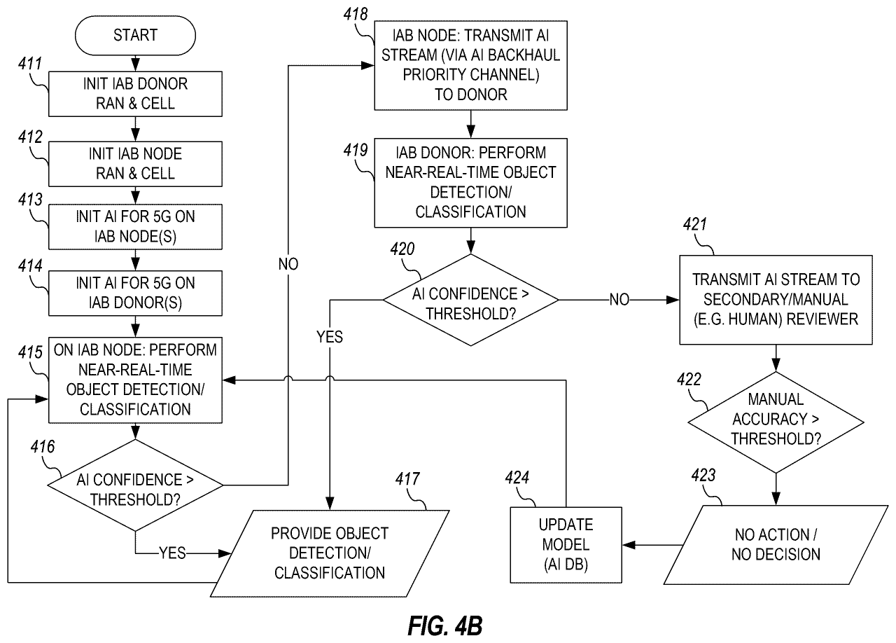

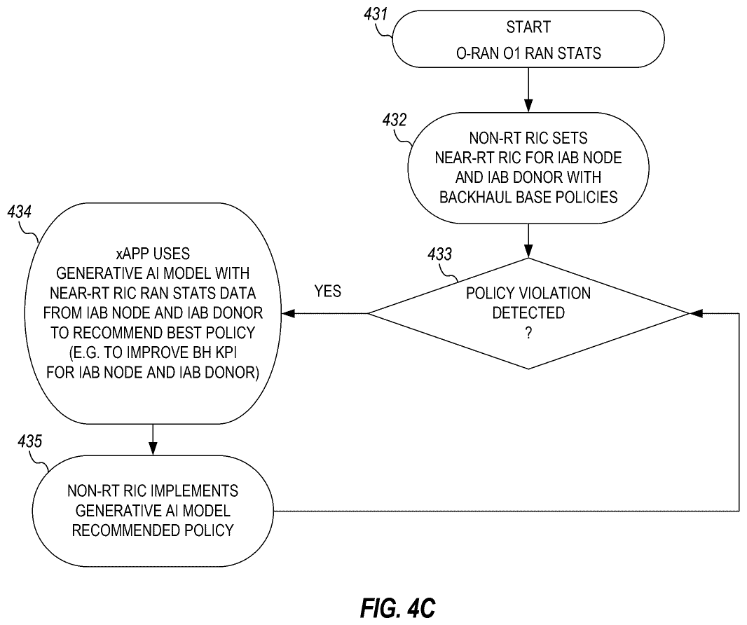

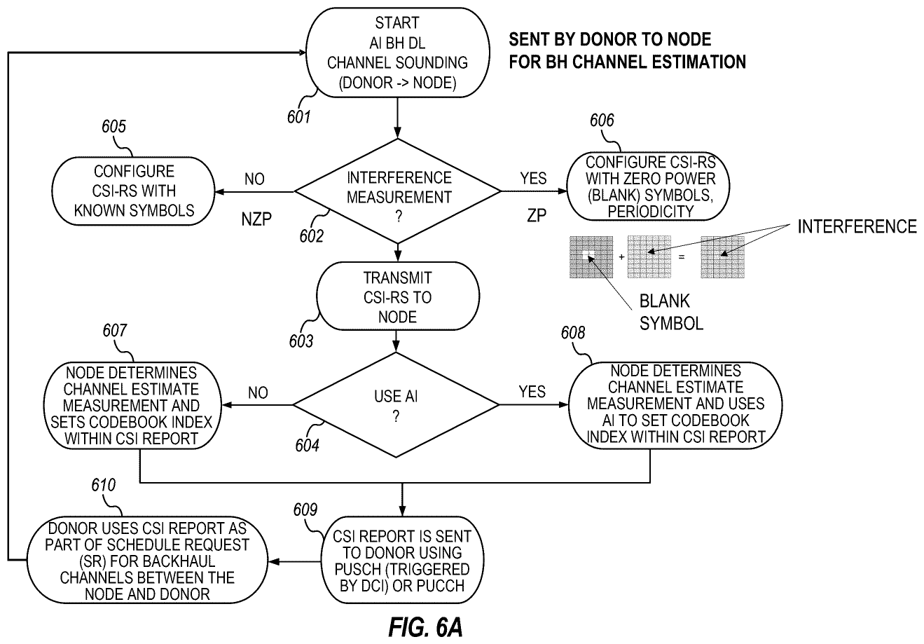

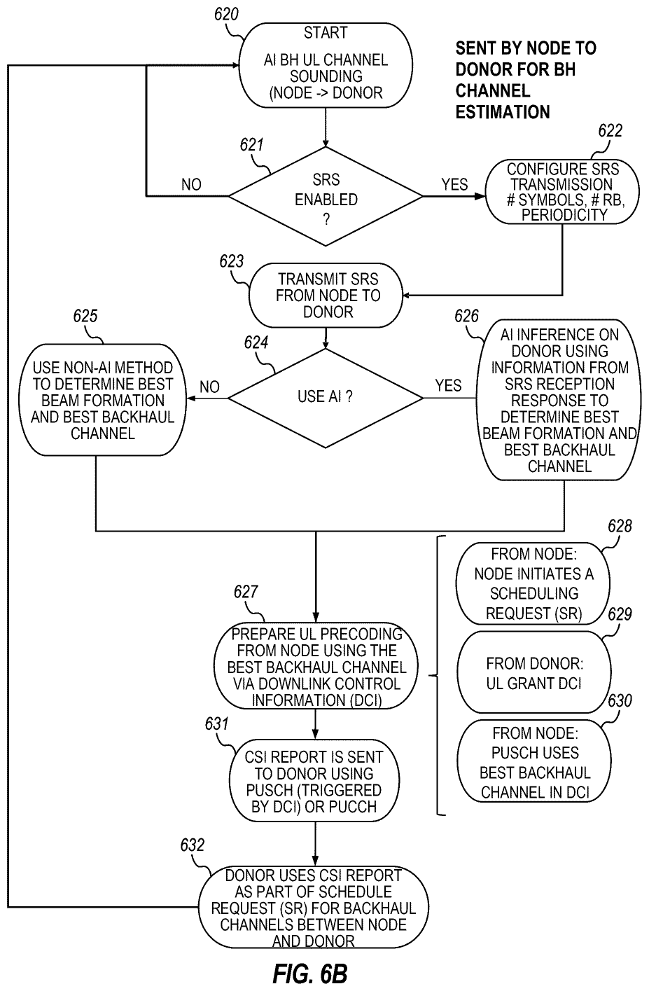

The following also introduces aspects of AI management within an IAB Node/Donor O-RAN to use and monitor overall IAB Node and IAB Donor usage via O1 interfaces, including to set and enforce policies on the IAB Node and IAB Donor via the A1 interfaces. This can be used to improve backhaul Signal-to-Interference-plus-Noise Ratio (SINR), thereby improving backhaul throughput since improved SINR results in improved throughput. This management includes macro-level policy enforcement and adjustments within the O-RAN framework (e.g., as depicted in FIG. 4C); whereas micro-level adjustments may be provided within an uplink (UL) or downlink (DL) connection between the IAB Node and IAB Donor (e.g., as depicted in FIGS. 6A and 6B). This adjustment may be accompanied by UL/DL backhaul channel sounding with statistics, which is used to help recognize a best-identified spectrum for the IAB Node to IAB Donor connections in near-real time. Accordingly, even if IAB Nodes move to different locations relative to the IAB Donor, the use of constant backhaul channel sounding can help adjust and maintain a link back to the IAB Donor and the network Core.

Among other use cases, IAB cells may be temporarily deployed to increase network capacity, including in emergency, disaster, failure remediation, network overload, bandwidth augmentation, or rapid deployment settings, at sports arenas, large cities, or large-scale public events, or in connection with other situations that necessitate extra capacity or mobility. In such contexts, a wireless backhaul may provide an important replacement to (or in addition to) the use of a physical media connection. The following configurations and techniques are therefore applicable to a variety of 5G network settings and use cases. These use cases include user equipment (UE) connected to self-backhauling wireless Base Stations (e.g., IAB-Nodes) and temporary virtualized radio access network (vRAN) systems. These use cases also include networks that perform communications using mm Wave band self-backhauling IAB-Nodes, where the higher frequency transmission rates are challenged due to short propagation lengths and path loss susceptibility.

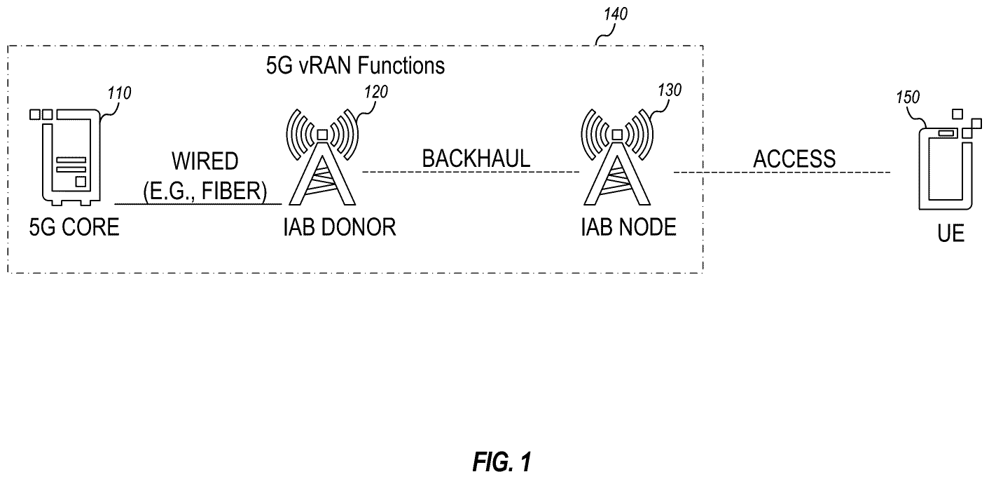

FIG. 1 provides an overview of network connectivity using one or more IAB Nodes and Donors. In many settings, an IAB Donor is defined to have a wired or fiber backhaul whereas IAB Nodes have no fixed wired or fiber backhaul; instead, the IAB Nodes use Frequency Range 1 (FR1, e.g., Sub-6 GHz) or Frequency Range 2 (FR2, e.g., mmWave) 5G frequencies to wirelessly backhaul traffic. As the name suggests, IAB is integrated and supports direct UE connections as well as wireless backhaul. In a typical configuration, an IAB Donor can serve one or multiple IAB Nodes, and the one or multiple IAB Nodes in turn can serve in a Donor role to other IAB Nodes.

Terrestrial IAB was introduced in 3GPP Rel 16 using the Backhaul Access Protocol (BAP), as defined in 3GPP TS 38.340). A respective IAB Node is considered a child of either an IAB Donor or an IAB Node. An IAB Node can then be a child of either another IAB Node or an IAB Donor. Each IAB Node child may introduce additional latency and consume the total backhaul bandwidth, and therefore the number of IAB Nodes may be limited to bandwidth and or latency constraints, although theoretically there are unlimited numbers of hops.

FIG. 1 specifically depicts a 5G Core 110 that utilizes a wired link (e.g., fiber or copper network) to an IAB Donor 120, and an IAB Donor 120 that uses a wireless backhaul to an IAB Node 130. This IAB Node 130 may be deployed at any number of locations or settings, to directly or indirectly provide access to a UE 150 (and other UEs not shown). A 5G virtualized radio access network (vRAN) is provided using vRAN functions 140 distributed among the 5G Core 110, the IAB Donor 120, and the IAB Node 130. The 5G Core 110, IAB Donor 120, and IAB Node 130 include respective hardware platforms and components (not depicted) for the execution of vRAN functions 140 that operate Layer 1 (L1), Layer 2 (L2), and/or Layer 3 (L3) layers via a software-based RAN stack.

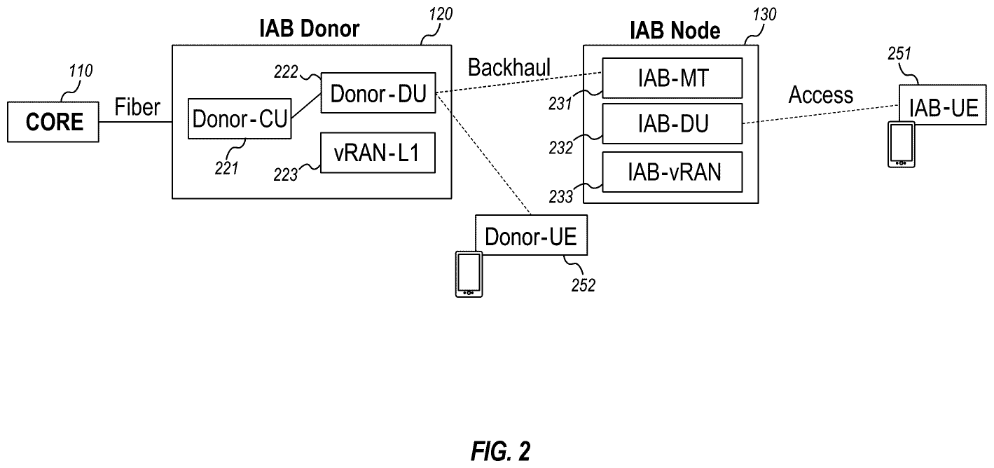

FIG. 2 depicts an architecture corresponding to the use of IAB nodes and donors. In an example, the IAB Donor 120 has a O-RAN 7.2 functional split using a centralized unit (CU) for higher protocol tasks (e.g., authentication, etc.). The CU (e.g., Donor-CU 221) includes one or more distributed units (DUs) (e.g., Donor-DU 222) responsible for time-sensitive tasks such as scheduling. The IAB Donor 120 also performs vRAN-L1 functions 223 via the vRAN. One or more UEs may be directly connected to the IAB Donor 120, such as shown with Donor-UE 252.

An IAB Node 130 includes a mobile termination (MT) function, shown as IAB-MT 231, which is responsible for wireless backhaul transmissions and is connected to the Donor-DU 222. The IAB Node DU function, shown as IAB-DU 232, is responsible for access transmissions to UEs such as an IAB-UE 251 (and, if applicable, to provide access to other backhaul IAB Nodes that might be connected to the IAB Node 130). The IAB Node 130 also includes an IAB-vRAN 233 used for performing vRAN functions at the IAB Node 130. An individual IAB Node can also operate as a parent to other IAB Nodes that are also composed of an MT and a DU.

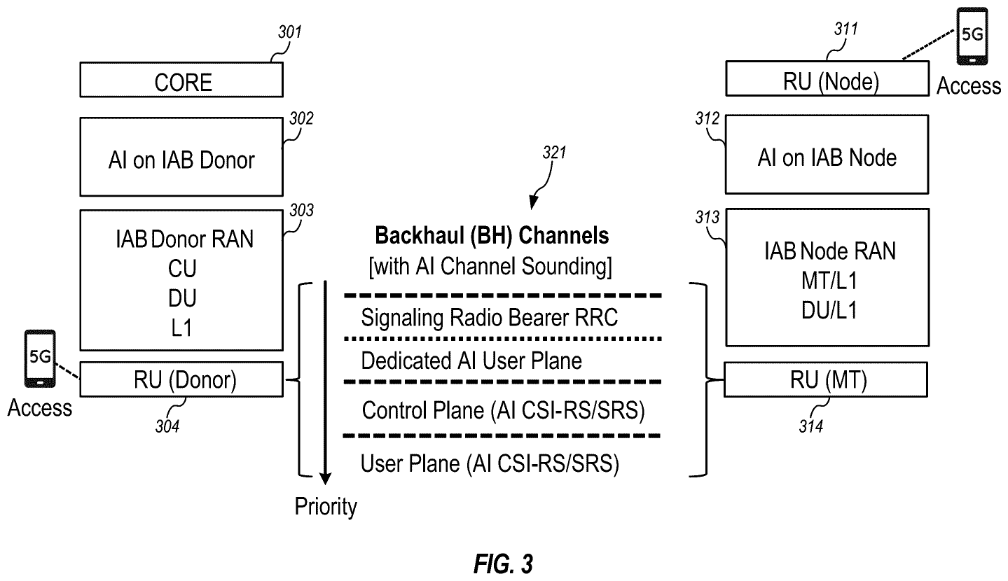

FIG. 3 depicts an architecture for implementing AI inferencing operations on an IAB Donor 302 and an IAB Node 312. An example implementation provided by this arrangement is the use of AI inferencing at the IAB Node and/or the IAB Donor using Backhaul (BH) Channel Sounding on BH channels 321, and AI inferencing at the IAB Node 312 or the IAB Donor 302 based on O-RAN Policies for BH Channel Service Level Agreement (SLA) Assurance. This enables an automatic, AI-based adjustment of the BH channels 321 between IAB Donor radio unit RU 304 and IAB Node RU 314 that can be interactively updated. In contrast, today's 5G RAN IAB configurations typically require a BH channel to be manually configured.

In an example, the IAB Node(s) act as Layer-2 relays, including functionality for encoding and decoding each packet prior to transmission regardless of packet origination or destination including UEs, other IAB nodes, or to and from an IAB Donor. The IAB Node RAN 313 includes an IAB-Mobile Termination (MT) module that links to the parent IAB Donor RAN 303 and an IAB Node DU that supports local UEs (e.g., via a RU 311) and links the IAB Node RAN to either an upstream IAB Donor RAN 303 and/or to another downstream IAB Node RAN (not shown) in a multi-hop scenario. The IAB Donor RAN 303 includes a centralized unit (CU), handling upper layer protocols including RRC and a distributed unit (DU) that handles lower protocols including PHY, MAC, and RLC.

The IAB Donor RAN 303 CU manages traffic to the CORE 301 and establishes connections to the IAB Donor DU with a wired connection and to downstream IAB Nodes wirelessly, as all CU to DU interactions use the 3GPP F1 interface. The wireless IAB Nodes are linked to the IAB Donor RAN 303 via a wireless backhaul utilizing the same NR FR1 or NR FR2 spectrum used for commercial UEs. Since this IAB Donor to IAB Node backhaul link uses the same NR F1/F2 spectrum as commercial 5G UE, Service Providers can reuse and leverage their existing licenses and add backhaul capabilities to their network topologies via IAB Nodes without the extra cost and infrastructure build out to establish fiber connections.

As will be understood, IAB Nodes can be temporarily deployed as a cell to provide service to UEs not easily served by traditional gNB wired cells. IAB Node startup is similar to a traditional UE startup in that the IAB Node acquires an IP address via a Protocol Data Unit (PDU) session from the 5G Core, thereby establishing a wireless backhaul link between the IAB Donor CU and the IAB Node DU via an F1 interface. After startup, the IAB Node acts as a Layer-2 relaying packets into and out of the IAB Node. A single-hop scenario has one IAB Node whereas a multi-hop has more than one IAB Node.

Different NR 5G frequencies can be used for IAB RAN Access and Backhaul links to mitigate interference or the same frequency can be used for in-band configurations. Mobile IAB Nodes require preservation and handover of the F1 link between the mobile IAB Node and IAB Donor to maintain transparent mobile IAB Node UE access.

A Terrestrial IAB Donor to IAB Node backhaul supports TDD and or FDD configurations. In other examples, a non-terrestrial network (NTN) backhaul can also be used instead of terrestrial network (TN) backhaul. Thus, the following aspects of AI for, on, or at an IAB Donor/Node also apply to Terrestrial and or Non-Terrestrial IAB pop-ups, regardless of TDD or FDD deployments. As will be understood, IAB Nodes and/or Donors can use a variety of CPU/GPU/NPUs, customer-specific SoCs, and/or use Edge-AI Orchestration. The use of Edge-AI orchestration may provide consistent Infrastructure and Edge-AI deployments (e.g., with OpenVINO-based AI Models).

FIG. 4A depicts a flowchart of a general approach for applying AI modeling and adjustments for a 5G RAN, for a self-healing IAB backhaul channel. Such adjustments may be needed whenever network changes occur as a result from IAB Node movement, environmental changes, and the like. This approach may integrate aspects from: (a) training an AI RAN IAB BH Model for different IAB Donor(s) or Donor configurations to evaluate IAB Node distances and environments; (2) validating the AI RAN IAB BH Model for accuracy; (3) installing and using an AI RAN IAB BH Model on an IAB Donor.

At operation 401, an initial backhaul policy is selected based on the environment for deployment of the IAB Donor and IAB Node. This may include, at operation 402, physically moving the IAB Node into a location that is intended for deployment of a new cell (e.g., based on movement of the IAB Node on a vehicle, drone, etc.). At operation 403, the IAB Donor and IAB Node are brought into operation, and commence operation based on an initial backhaul policy. At operation 404, an AI Inference Engine is brought into operation on the IAB Donor and the IAB Node.

At operation 405, the RAN IAB channel sounding begins, and information from the backhaul channel characteristics is fed to an AI model operated by an AI engine. The AI engine analyzes this information and may recommend changes as determined at decision 406. Based on the AI-recommended changes, updates are made to the backhaul channel at operation 407 such as to move to one or more of the channels to a different part of the channel bandwidth, to change a priority of one or more of the channels, and the like. Based on these updates, additional policy changes may be determined and updated at operation 408. Operations 405 and decision 406 are then repeated.

The deployment of this policy in FIG. 4A (e.g., at operation 401), can be provided via a pre-trained RL model (e.g., via a trained neural network) that would have been trained on simulated/approximated versions of the general environments that the system is expected to deploy in. The RL model can provide a decision making strategy from encoded weights produced from training on environment-specific data. As will be understood, when a trained model is deployed, the environment will not be exactly like the simulated environment it was trained on, although recommended changes can be identified to continually adapt the model based on feedback, rewards, and updates. This provides a suitable way to deploy RL models when there is a partially predictable environment (desert, urban, etc.), while allowing tuning for deployment in a slightly different environment. In further examples, the policy can be frozen at any point (updating periodically based on known downtimes, etc.), such as when online learning is too intensive for the resources available. Actions and corresponding rewards can be also logged to provide data for further learning in offline situations.

FIG. 4B depicts a flowchart of an approach for applying AI modeling and adjustments in a 5G RAN, using a self-healing IAB backhaul channel for near-real-time data analysis. Specifically, this flowchart shows an approach for using an AI model to perform near-real-time object detection at either the IAB Node or an IAB Donor, with data transmitted via the self-healing IAB backhaul channel. This object detection may be selectively performed at the IAB Node or the IAB Donor based on a confidence level or threshold.

In particular, FIG. 4B provides the use of a specific AI model (e.g., deploying an object detection model on both IAB Node and Donor systems) to perform hierarchical inferencing by performing inferencing at the IAB Node, and receiving a confidence value from the model for each inference. If the AI model is not very confident in its detection(s) (e.g., the confidence is below a threshold) then the data can be upstreamed to the IAB Donor (via an AI backhaul priority channel) since the Donor ideally has more computational/memory resources to make a more confident detection. This hierarchical approach can balance near-real-time inferencing with appropriate confidence in the results.

In detail, the flowchart of FIG. 4B shows initialization of the IAB Donor and IAB Node. At operation 411, the IAB Donor RAN and Cell is initialized, and at operation 412, the IAB Node RAN and Cell is initialized. Then, at operation 413, AI for 5G is initialized at the IAB Node(s), and at operation 414, AI for 5G is initialized at the IAB Donor(s).

At operation 415, near-real-time object detection, classification, and/or analysis is performed at the IAB Node. The results of this detection, classification, and/or analysis are evaluated at decision 416. If the confidence in the AI detection, classification, and/or analysis from the IAB Node exceeds some threshold, then an object detection or classification can be provided (output) at operation 417. The detection/classification operations can be repeated for additional objects or data.

If the confidence in the AI detection, classification, and/or analysis does not exceed the threshold, then coordinated operations are performed between the IAB Node and the IAB Donor. At operation 418, the IAB Node transmits the AI stream, via an AI backhaul priority channel, to the IAB Donor. At operation 419, the IAB Donor performs near-real-time object detection, classification, or analysis. The results from this detection, classification, and/or analysis are evaluated at decision 420. If the confidence in the AI detection, classification, and/or analysis from the IAB Donor exceeds some threshold, then an object detection or classification can be provided (output) at operation 417.

If the confidence in the AI detection, classification, and/or analysis does not exceed the threshold, then various remedial actions may be performed. This may include transmitting the AI stream to a secondary or manual reviewer (e.g., a human) at operation 421, performing a manual evaluation of the accuracy relative to the threshold at decision 422, and receiving the results of an action or a decision (or, no action or no decision) at operation 423. The resulting determination from the manual evaluation can be used, in some optional examples, to update the model at operation 424, or otherwise provide a revision to an AI database.

FIG. 4C depicts a flowchart of an approach for using AI to evaluate policies and recommend a best policy to improve BH key performance indicators (KPIs) for an IAB Node and an IAB Donor. These policies are evaluated in the context of an O-RAN configuration.

The flowchart of FIG. 4C specifically depicts the use of a generative AI model to produce a policy recommendation. Other types of AI models with a sequential architecture such as an LSTM or RNN can be used to process chunks of stats data and classify the best policy from a predefined policy set. Alternatively, an RL model can be used to provide a best action given an environment state.

At operation 431, the O-RAN begins the collection of O1 RAN stats, which are performance management statistics collected via the O1 interface. These stats can be coordinated with the O-RAN RAN intelligent controller (RIC) as follows. At operation 432, the non-real-time RIC (Non-RT RIC) implements policies at the near-real-time RIC (Near-RT RIC) for the IAB Node and the IAB Donor, using backhaul base policies. At decision 433, an evaluation is performed on whether a policy is violated. If a policy violation is detected, then at operation 434, an AI model is used to determine a change in the policy.

In an example, an xAPP (e.g. a third party app) uses a generative AI model to analyze the near-RT RIC RAN stats data from the IAB Node and the IAB Donor to recommend a best policy that would improve the backhaul KPIs for the IAB Node and the IAB Donor. At operation 435, the non-RT RIC implements the generative AI model-recommended policy. Further evaluation can be performed with decision 433, after implementing and using the recommended policy in O-RAN configuration.

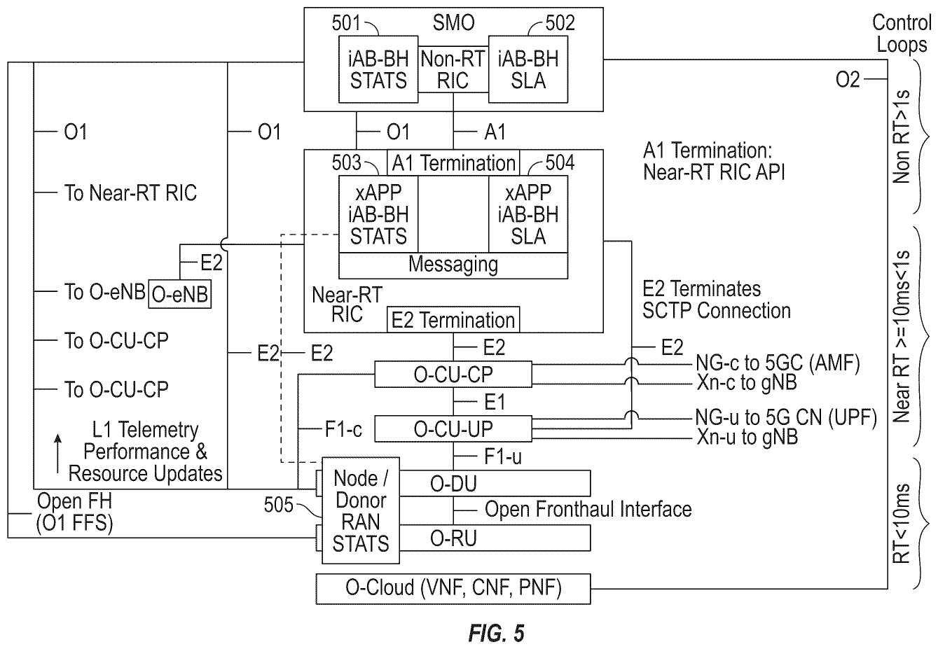

FIG. 5 depicts a block diagram of statistic collection operations in an O-RAN configuration supporting an IAB Node and IAB Donor, to provide information to evaluate policies (e.g., in accordance with FIG. 4C). Here, this block diagram shows how IAB-BH stats 501 are collected at a Non-RT RIC. The IAB-BH stats 501 may be compared to the use of an SLA, such as an IAB-BH SLA 502. Next, the block diagram of FIG. 5 shows how xAPP IAB-BH stats 503 are collected at the Near-RT RIC. The xAPP IAB-BH stats 503 also may be compared to the use of an SLA such as an xAPP IAB-BH SLA 504.

Additional RAN stats may be collected for communications between an IAB Node and an IAB Donor, such as is shown with Node/Donor RAN Stats 505 collected between O-DU and O-RU. Thus, as shown, statistics and SLAs may be collected and evaluated in the O-RAN architecture with real-time (e.g., <10 ms), near-real-time (e.g., >=10 ms<1 s), or non-real-time (e.g., >1 s) interfaces and RICs.

FIG. 6A depicts a flowchart of another approach for applying AI modeling and adjustments in a 5G RAN, for a downlink (DL), with information sent by an IAB Donor to an IAB Node for BH Channel Estimation.

At operation 601, the flowchart begins with the use of AI backhaul DL channel sounding, from the IAB Donor to the IAB Node. At evaluation 602, an interference measurement is determined for the channel sounding. If the interference measurement is detected, then a channel state information reference signal (CSI-RS) is configured with zero power (blank) symbols and periodicity at operation 605. If the interference measurement is not detected, then a CSI-RS is configured with known symbols at operation 606.

Next, at operation 603, the CSI-RS is transmitted to the IAB Node. At evaluation 604, a decision is made on whether to use AI adjustments. If AI adjustments will not be used, then the IAB Node determines a channel estimate measurement and sets a codebook index within a channel state information (CSI) report at operation 607. If AI adjustments will be used, then at operation 608, the IAB Node determines a channel estimate measurement, and uses an AI model to determine a codebook index and other related information for a best beam formation (beamforming pattern) to be included within a CSI report.

Next, at operation 609, the CSI report is sent to the donor, such as using the Physical Uplink Shared Channel (PUSCH) (e.g., triggered by a downlink control information (DCI) message) or the Physical Uplink Control Channel (PUCCH). At operation 610, the donor uses the CSI report, such as part of a schedule request for backhaul channels between the IAB Node and IAB Donor.

FIG. 6B depicts a flowchart of another approach for applying AI modeling and adjustments in a 5G RAN, for an uplink (UL), with information sent by an IAB Node to an IAB Donor for BH Channel Estimation.

At operation 620, the flowchart begins with the use of AI backhaul UL channel sounding, from the IAB Node to the IAB Donor. At evaluation 621, an evaluation is determined whether a sounding reference signal (SRS) is enabled. If the SRS is not in use, then the UL channel sounding is not performed. If the SRS is in use, then an SRS transmission is configured at operation 622, including the number of symbols, the number of resource blocks (RBs), and the periodicity of the SRS.

Next, at operation 623, the configured SRS is transmitted from the IAB Node to the IAB Donor. At evaluation 624, a determination is made on whether to use AI adjustments. If AI adjustments will not be used, then at operation 625, a non-AI method (e.g., a rule) is used to determine the best beam formation and the best backhaul channel based on the SRS reception response. If AI adjustments will be used, then at operation 625, the IAB Donor performs an AI inference using information from the SRS reception response. The AI inference, for instance, can determine a best beam formation (beamforming pattern) and a best backhaul channel for use, for individual or multiple channels.

Based on the beam formation and the backhaul channel selected at operations 625 or 626, an UL precoding is prepared from the IAB Node, using the selected backhaul channel, for communication of a DCI message. This can include: at operation 628, the IAB Node initiating a scheduling request (SR); at operation 629, the IAB Donor providing an uplink grant of resources based on the DCI message; and at operation 630, operating PUSCH using the selected backhaul channel with the DCI message.

Based on this information at operation 631, a CSI report is sent to the IAB Donor using PUSCH (e.g., triggered by DCI) or using PUCCH. Finally, at operation 632, the IAB Donor uses a CSI report as part of the schedule request for the backhaul channels between the IAB Node and the IAB Donor. The overall process depicted in FIG. 6B can then be repeated, starting again at operation 620.

In an example, an AI Prioritized channel is scheduled after the SR. Logical Channel Prioritization (LCP) occurs during each PDU session and a “priority” is set within the IAB BH channels (e.g., in accordance with 3GPP TS 38.321 v. 17.0.0; section 5.4.3.1.1). For instance, to prioritize the AI/ML Traffic, a priority is selected with a low number (e.g., 2) for AI/ML traffic and a higher number for User Plane Traffic (e.g., 4).

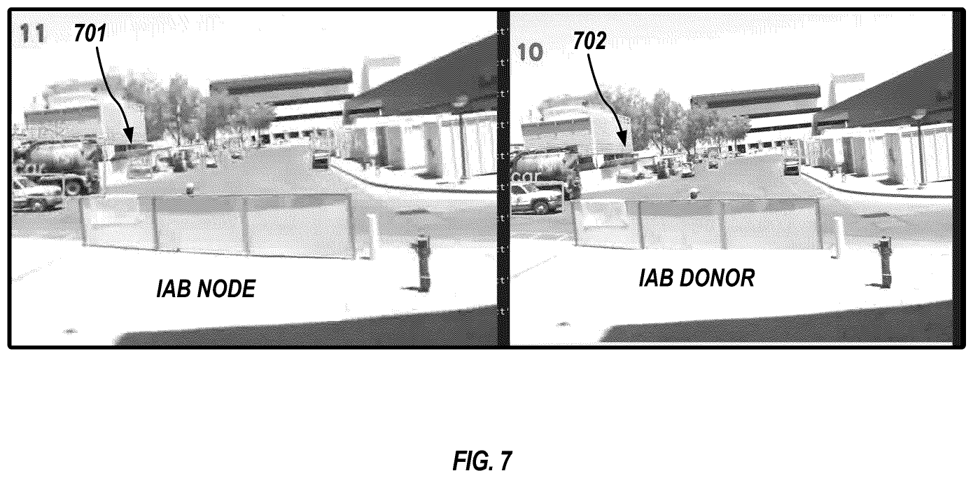

FIG. 7 depicts results of inferencing on an IAB Node and IAB Donor. Here, inferencing results 701 on the IAB Node differ from inferencing results 702 on the IAB Donor. This is due to variations of inference time and processing results on the IAB Node (e.g., where the data is captured, but where limited processing resources reside) and the IAB Donor (e.g., having additional processing resources, but subject to a communication delay). In some examples, a simultaneous feed of data is provided to the RAN Node and the RAN Donor, leading to different results from simultaneous analysis, such as due to increased accuracy from the use of different/additional data models that are more computationally expensive. Various combinations of AI model analysis may result operations performed on the IAB Node, the IAB Donor, and other parties (e.g., a cloud service). Accordingly, multiple aspects of simultaneous IAB Donor and IAB Node(s) object detection/tracking/classification can be coordinated.

Results of inferencing include but are not limited to object detection, object classification, pose detection, among many other use cases. The use of object detection and bounding boxes may also provide an optimized set of data. For instance, only data within a particular bounding box may be transmitted or analyzed by the IAB Donor (e.g., based on coordinates of the bounding box being sent over the backhaul channel, or a cropped portion of the image being sent over the backhaul channel).

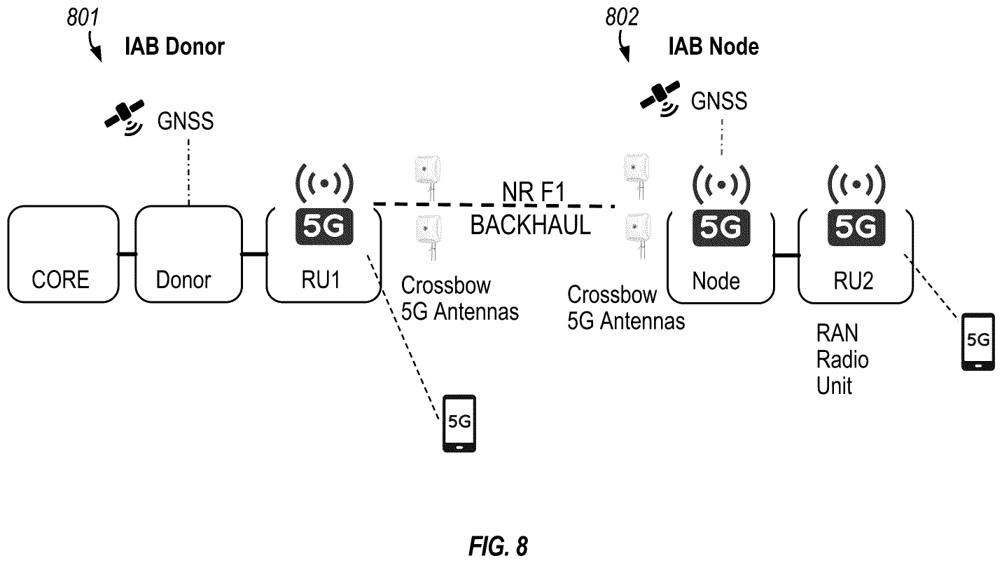

FIG. 8 depicts an example of a RAN configuration between an IAB Donor 801 and an IAB Node 802. Here, Global Navigation Satellite System (GNSS) data is used at the IAB Donor 801 and the IAB Node 802 for time synchronization. To enable IAB, an update of the UE provision settings is performed, and then the Core Network Access and Mobility Management Function (CN AMF) is enabled/updated. Although only one donor and node pair are depicted, it will be understood that many nodes may be served by a particular donor via the same backhaul link.

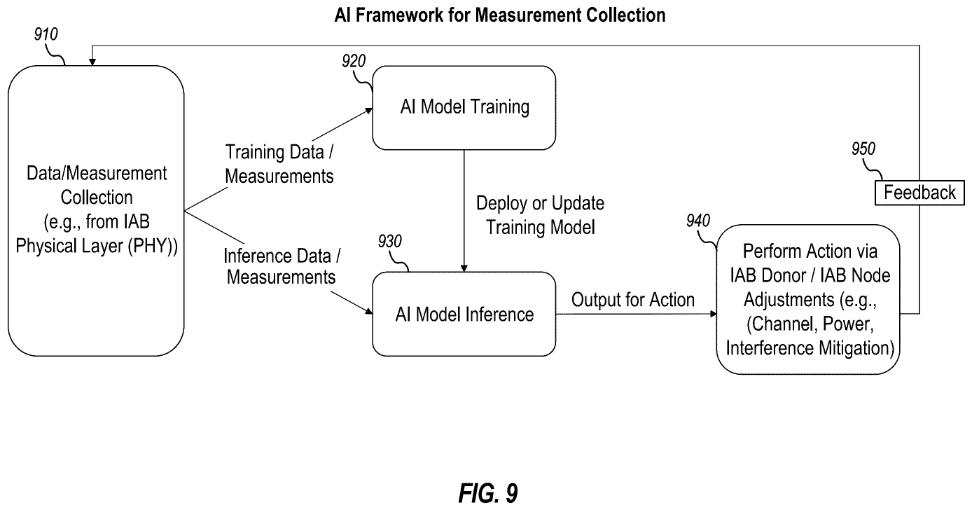

FIG. 9 depicts an approach for using Artificial Intelligence directed at the collection of data and measurements for an AI Training and Learning functional framework. Specifically, this approach shows how IAB physical layer (PHY) data and measurements are collected for use in training and inference scenarios. Other sources of data and measurements may be added to training and inference operations.

First, operation 910 shows a Data/Measurement collection (e.g., from the IAB physical layer (PHY)), with these data/measurements to provide input data for training operations 920 and inference operations 930. This input data may include but is not limited to IAB gNB PHY and UE data and measurements-such as channel state information, or responses from reference signals such as RSRP (Reference Signal Received Power) and RSRQ (Reference Signal Received Quality)—within the currently used channels. This input data may be based on communications from not only the frequency channel for the IAB backhaul or access communication, but also from other portions of the available bandwidth associated with numerology of the IAB Donor or IAB Node. Measurements from Physical layers can include reference signals that could be used to derive measurements and detect the channel state information. Thus, measurements may also include or be based on power and/or amplitude-related responses (e.g., to detect signal strength and anomalies associated with over-the-air transmission).

These and similar measurements can be used as inputs to an AI Model (for training operations 920 or inference operations 930), or to trigger automated alerts and actions that cause adjustments in the network configuration (such as at operation 940). Feedback 950 that is collected from the performed action may also provide additional data measurements for additional training and inference.

Options for training a relevant AI model can include: (1) joint training between a parent IAB-Donor and a child IAB-Node, (2) separate training at the IAB-Donor and a IAB-Node, including in scenarios where the model from each can be shared with the other; or (3) either joint or separate with collaboration from a Donor-UE and or an Access-UE and or IAB-MT.

In a further example, the “IAB” Information Elements of the Node to/from Donor Backhaul and/or Node to/from UE Access can be captured in real-time and analyzed with the AI model. This may enable reference signal analysis, PHY stats analysis, power analysis, quality analysis, and backhaul access protocol analysis to be performed at a respective hop. Based on one or more of the analysis, actions may be implemented including to adjust Donor DU and/or Access DU scheduling changes (including TDD/FDD spectrum partitioning and or different patterns).

In this context, the “IAB” Information Elements can include but are not limited to a mixture of CU/DU related elements:
Bit Error Rate;
Noise Ratio;
Flux Density;
Antenna Gain;
RSRP (Indicates the value of reference signal [e.g., SRS] received power);
RSRQ (Indicates the value of reference signal [e.g., SRS] received quality);
SINR (Indicates the value of signal to interference plus
noise ratio);
Packet stats; and
Handover stats;

Other measurement information used for training and inference/analysis may include counters, such as:
Layer 1 (L1) Radio Resource Control (RRC), Protocol Data Unit (PDU), Data Radio Bearer (DRB), Quality of Service (QOS), Guaranteed Bit Rate (GBR) related counters, including both user equipment (UE) and mobile termination (MT) connections successfully made, attempted or rejected, re-establishments, handover attempt releases, and establishment times to/from a gNB Donor and/or to/from IAB-Node(s) toward the gNB Donor and/or toward UE(s));
Layer 2 (L2) Media Access Control (MAC)-related RACH counters including UL and DL Channel Quality Indicator (CQI) and Quadrature Amplitude Modulation (QAM) transportation blocks attempted, rejected, and successful to/from gNB Donor and/or to/from IAB-Node(s) toward the gNB Donor and/or toward UE(s);
Layer 3 (L3) IP Packet Throughput-related counters including MT and UE throughput statistics, blocks attempted/rejected/successful to/from gNB Donor and/or to/from IAB-Node(s) toward the gNB Donor and or toward UE(s); and
Non-Terrestrial (Satellite)-related counters and statistics including Non-Terrestrial Networks (NTN) parameters required for the UE to access a Donor gNB and or IAB-DU through an NTN.

In specific examples, NTN measurements may include or relate to any of the following: debris; downlink data bandwidth; radio frequency interference (RFI); ground station coverage; government (e.g., FCC) restrictions; natural (solar, ionospheric) interference; attitude changes (e.g., in low-earth orbit (LEO) satellite constellations) that impact antenna gain, RF received power, or Effective Isotropic Radiated Power; LEO constellation hardware/silicon specification deviations that affect the amount of power a satellite has in real-time to adjust antenna power, ground station low noise amplification, satellite altitude and line of sight to ground station, or dipole/phased array antenna gains; Bit Error Rate; Carrier to Noise Ratio; Flux Density; Received Isotropic Power (RIP); Effective Isotropic Radiated Power (EIRP); Antenna Gain; or Proximity constraints (e.g., a fly-by exclusion or coordination zone).

AI Training/Learning can be performed at the IAB Node toward the IAB Donor (backhaul) and/or at the IAB Node toward the UE (access). AI Training Data/Measurements can also include other types of upper-layer network measurements and statistics, including packets transmitted, packets dropped, packets retransmitted, dropped calls, number of handovers, and the like. Additionally, BAP hop-to-hop packets that are determined at a respective hop (instead of end-to-end) may provide useful information.

In still further examples, AI Training Data/Measurements can also be related to interference detection metrics. Counters (including the counters identified above) may be used as part of AI Inferencing and Learning/Training, including to reinforce actual data collected for training.

An AI Model Inference task may be created based on the output data received by the IAB Donor/Node Actor, to cause actions and implement load balancing adjustments that improve IAB Nodes and connected UEs. IAB nodes that perform load balancing can be actioned by changing TDD patterns, changing beam direction and beamforming based on active, changing RX/TX power on the IAB-DU Node, IAB-DU/CU Donor, and or both. Other variations of TDD/FDD changes and adaptations may also be used.

Finally, it will be understood that AI Model execution and placement can occur with (but is not limited to) a specific IAB-Node (hop) or on multiple/all IAB-Nodes (hops), executed using processing circuitry (e.g., at least one CPU and/or GPU). Thus, many variations of AI model inferencing and training can occur in a relevant IAB deployment.

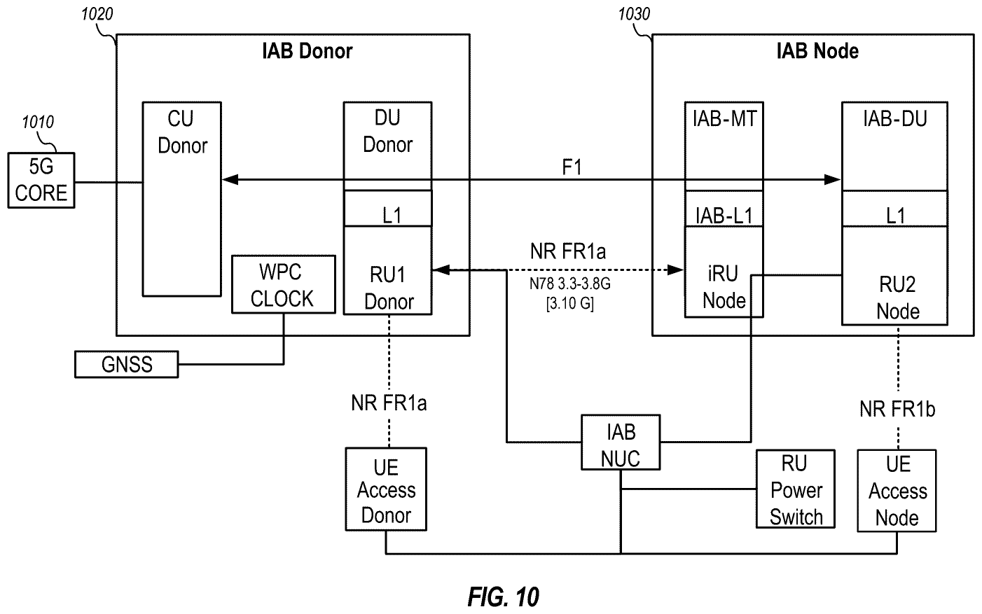

FIG. 10 depicts further scenarios of IAB Nodes for 5G connectivity. Here, FIG. 10 shows an architecture of a donor-node network arrangement, which may collect data and provide network connectivity using IAB as discussed herein. The IAB Donor 1020 provides connectivity and control to the IAB Node 1030, via F1 and NR FR1a interfaces.

In specific examples, data can be collected from this network arrangement for AI model training or inferencing, including an AI model used for network interference measurement, condition detection, and/or analysis of fingerprint reference measurements. The data collected for AI model training can include: (1) joint training on data between a parent IAB-Donor and a child IAB-Node; (2) separate training on data from the parent IAB-Donor and a child IAB-Node, with the model used at one location being shared with the other location; or (3) either joint or separate training, using collaboration of data from a donor-UE and or an access-UE and or IAB-MT. Thus, it will be understood that AI Training/Learning can be performed at a Node toward Donor (backhaul) and/or Node toward UE (access). Further, there may be one: many donor: nodes. Further hardware configurations used for these options may include hardware and software circuitry (including CPU+ memory and/or GPU+ memory circuitry combinations) on an IAB Node and or IAB Donor (server).

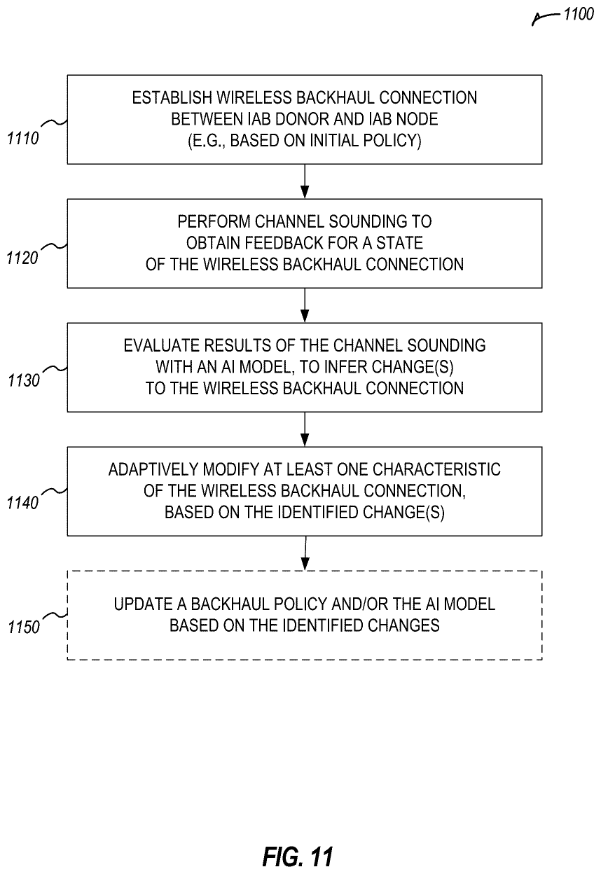

FIG. 11 depicts a flowchart 1100 of an example method for operating an adaptive backhaul channel for use in an IAB deployment. This method may be used to implement all or portions of the adaptive IAB backhaul channel configuration, using the operations depicted among FIGS. 3 to 6B.

At operation 1110, an IAB wireless backhaul connection is established or identified, for a backhaul between an IAB Donor and an IAB Node as discussed above. The wireless backhaul connection may be configured or adapted to include multiple channels including a dedicated backhaul channel, a control channel, and a data channel. In an example, this wireless backhaul connection is established and configured based on an initial backhaul policy.

At operation 1120, channel sounding is performed to obtain feedback and measurements for a state of the wireless backhaul connection. This channel sounding is performed via the control channel, and includes the exchange of reference signals that provide feedback for a state of the wireless backhaul connection. The channel sounding method that is used can be different depending on the direction, e.g., using a first UL channel sounding method (from the IAB Node(s) to the IAB Donor) versus a second DL channel sounding method (from the IAB Donor to the IAB Node(s)).

At operation 1130, the results of the channel sounding are evaluated with at least one trained AI model that performs inferencing (such as the AI model discussed above with reference to FIG. 9). The AI model may receive input data from the real-time channel sounding feedback and measurements, and may provide output data that recommends at least one identified change to the wireless backhaul connection, including for future use (e.g., in the next n milliseconds) with backhaul scheduling. For instance, the channel sounding can be used to detect interference that occurs on the wireless backhaul connection, and the trained AI model can output the at least one identified change which is identified to most appropriately reduce the interference.

At operation 1140, at least one characteristic of the wireless backhaul connection is adaptively modified, based on the at least one identified change. This may include the adaptive modification of the channels and characteristics of the wireless backhaul connection. For example, the at least one identified change to the wireless backhaul connection may cause a change a bandwidth or a priority of the dedicated backhaul channel. Another example may include changing a modulation coding scheme value higher or lower, depending on interference within the dedicated backhaul channel or other effects occurring on the backhaul channel(s).

At operation 1150, the backhaul policy (such as the initial backhaul policy or a current backhaul policy) is updated based on the at least one identified change. This policy may further evaluate other aspects of service quality, SLAs, and operational status as discussed above.

As discussed above with FIGS. 6A to 6B, the channel sounding may be sent by the IAB Donor to the IAB Node, or by the IAB Node to the IAB Node, for BH channel estimation. In a first example where the channel sounding is performed based on a downlink from the IAB Donor to the IAB Node, and the channel sounding is based on a channel state information reference signal (CSI-RS) provided to the IAB Node via the downlink. In this setting, the trained AI model may determine a beamforming pattern to include within a channel state information (CSI) report, where the CSI report is provided from the IAB Node to the IAB Donor in response to the CSI-RS. In a second example where the channel sounding is performed based on an uplink of the wireless backhaul connection from the IAB Node to the IAB Donor, the channel sounding includes use of a sounding reference signal (SRS) provided from the IAB Node to the IAB Donor via the uplink. In this setting, the trained AI model (e.g., on the Donor) uses information from the SRS to determine a beamforming pattern and an optimization for the dedicated backhaul channel.

In further examples, the optimization of the wireless backhaul connection may support the use of the dedicated backhaul channel to exchange inferencing data and inferencing results between the IAB Node and the IAB Donor based on processing capabilities at the IAB Node or the IAB Donor. As discussed above, such inferencing data may include information from at least one sensor at the IAB Node (or results of initial inferencing at the IAB Node), and the inferencing results may include information from an execution of at least one AI model at the IAB Donor. In still further examples, an additional channel(s) dedicated for backhaul can be deployed or enabled to increase bandwidth and/or to provide lower latency transport for future AI analysis at the IAB Donor. This is particularly relevant in scenarios for tiered AI inference processing where the IAB Node does not have enough processing power or capacity to provide results, so the AI inference is performed at the IAB Donor, provided back to the IAB Node, and then communicated to a connected device or user. This is particularly relevant in cases where the IAB Donor has large inference processing capabilities with a GPU array, whereas the IAB Node hosts CPU-only inference processing capabilities.

### Implementation in Edge Computing Scenarios

It will be understood that the present communication and networking arrangements may be implemented with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

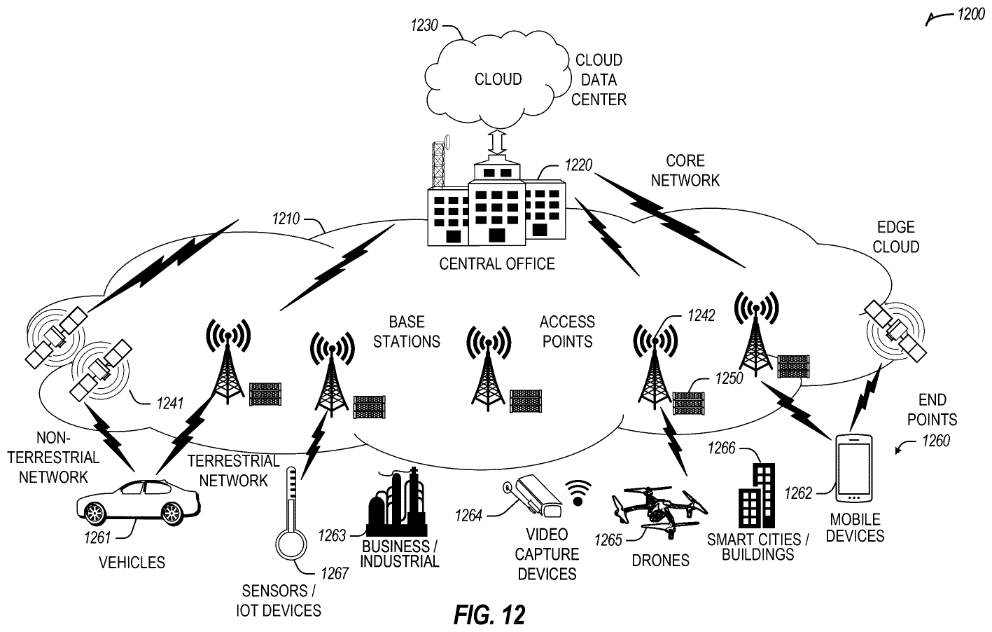

FIG. 12 is a block diagram 1200 showing an overview of a configuration for edge computing, which includes a layer of processing referenced in many of the current examples as an “edge cloud”. This network topology, which may include a number of conventional networking layers (including those not shown herein), may be extended through use of the satellite and non-terrestrial network communication arrangements discussed herein.

As shown, the edge cloud 1210 is co-located at an edge location, such as a satellite vehicle 1241, a base station 1242, a local processing hub 1250, or a central office 1220, and thus may include multiple entities, devices, and equipment instances. The edge cloud 1210 is located much closer to the endpoint (consumer and producer) data sources 1260 (e.g., autonomous vehicles 1261, user equipment 1262, business and industrial equipment 1263, video capture devices 1264, drones 1265, smart cities and building devices 1266, sensors and IoT devices 1267, etc.) than the cloud data center 1230. Compute, memory, and storage resources which are offered at the edges in the edge cloud 1210 are critical to providing ultra-low or improved latency response times for services and functions used by the endpoint data sources 1260 as well as reduce network backhaul traffic from the edge cloud 1210 toward cloud data center 1230 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time. In scenario of a non-terrestrial network, distance and latency may be far to and from the satellite, but data processing may be better accomplished at edge computing hardware in the satellite vehicle rather than requiring additional data connections and network backhaul to and from the cloud.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource may be “moved” to the data, as well as scenarios in which the data may be “moved” to the compute resource. Or as an example, base station (or satellite vehicle) compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 12, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges. The extension of satellite capabilities within an edge computing network provides even more possible permutations of managing compute, data, bandwidth, resources, service levels, and the like.

Depending on the real-time requirements in a communications context, a hierarchical structure of data processing and storage nodes may be defined in an edge computing deployment. For example, such a deployment may include local ultra-low-latency processing, regional storage and processing as well as remote cloud data center based storage and processing. KPIs may be used to identify where sensor data is appropriately transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data center.

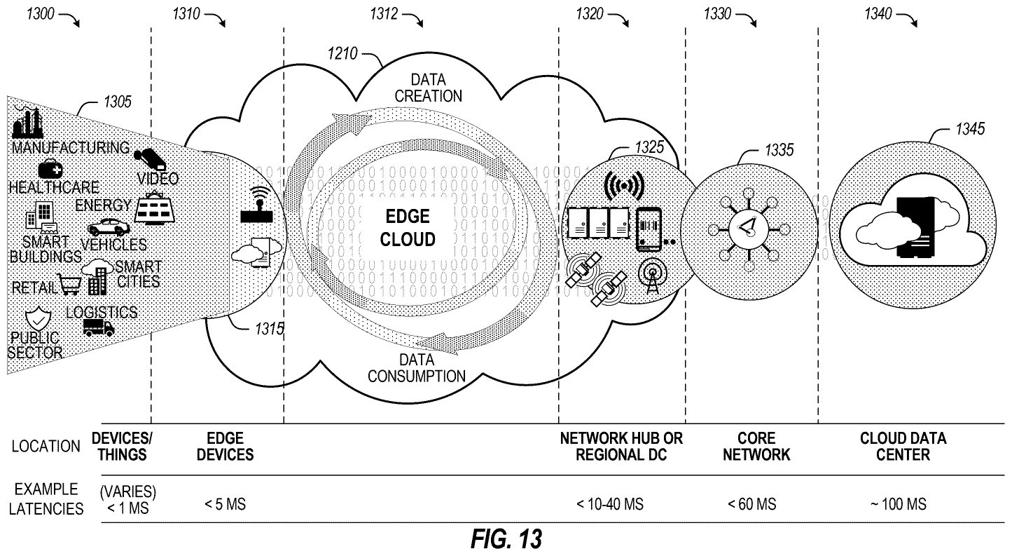

FIG. 13 illustrates operational layers among endpoints, an edge cloud, and cloud computing environments. Specifically, FIG. 13 depicts examples of computational use cases 1305, utilizing the edge cloud 1210 among multiple illustrative layers of network computing. The layers begin at an endpoint (devices and things) layer 1300, which accesses the edge cloud 1210 to conduct data creation, analysis, and data consumption activities. The edge cloud 1210 may span multiple network layers, such as an edge devices layer 1310 having gateways, on-premise servers, or network equipment (nodes 1315) located in physically proximate edge systems; a network access layer 1320, encompassing base stations, radio processing units, network hubs, regional data centers (DC), or local network equipment (equipment 1325); and any equipment, devices, or nodes located therebetween (in layer 1312, not illustrated in detail). The network communications within the edge cloud 1210 and among the various layers may occur via any number of wired or wireless mediums, including via connectivity architectures and technologies not depicted.

Examples of latency with terrestrial networks, resulting from network communication distance and processing time constraints, may range from less than a millisecond (ms) when among the endpoint layer 1300, under 5 ms at the edge devices layer 1310, to even between 10 to 40 ms when communicating with nodes at the network access layer 1320. (Variation to these latencies is expected with use of non-terrestrial networks). Beyond the edge cloud 1210 are core network and cloud data center layers 1330 and 1340, with increasing latency (e.g., between 50-60 ms at the core network layer 1330, to 100 or more ms at the cloud data center layer). As a result, operations at a core network data center 1335 or a cloud data center 1345, with latencies of at least 50 to 100 ms or more, will not be able to accomplish many time-critical functions of the use cases 1305. These latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1335 or a cloud data center 1345, a central office or content data network may be considered as being located within a “near edge” layer (“near” to the cloud, having high latency values when communicating with the devices and endpoints of the use cases 1305), whereas an access point, base station, on-premise server, or network gateway may be considered as located within a “far edge” layer (“far” from the cloud, having low latency values when communicating with the devices and endpoints of the use cases 1305). It will be understood that other categorizations of a particular network layer as constituting a “close”, “local”, “near”, “middle”, or “far” edge may be based on latency, distance, number of network hops, or other measurable characteristics, as measured from a source in any of the network layers 1300-1340.

The various use cases 1305 may access resources under usage pressure from incoming streams, due to multiple services utilizing the edge cloud. To achieve results with low latency, the services executed within the edge cloud 1210 balance varying requirements in terms of: (a) Priority (throughput or latency) and Quality of Service (QOS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at a respective layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 1210 may provide the ability to serve and respond to multiple applications of the use cases 1305 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), etc.), which might not leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power uses greater memory bandwidth. Likewise, improved security of hardware and root of trust (RoT) trusted functions are also implicated, because edge locations may be unmanned and may even need permissioned access (e.g., when housed in a third-party location). Such issues are magnified in the edge cloud 1210 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1210 (network layers 1300-1340), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), communication services provider (CoSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, circuitry, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1210.

As such, the edge cloud 1210 is formed from network components and functional features operated by and within edge gateway nodes, edge aggregation nodes, or other edge compute nodes among network layers 1310-1330. The edge cloud 1210 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

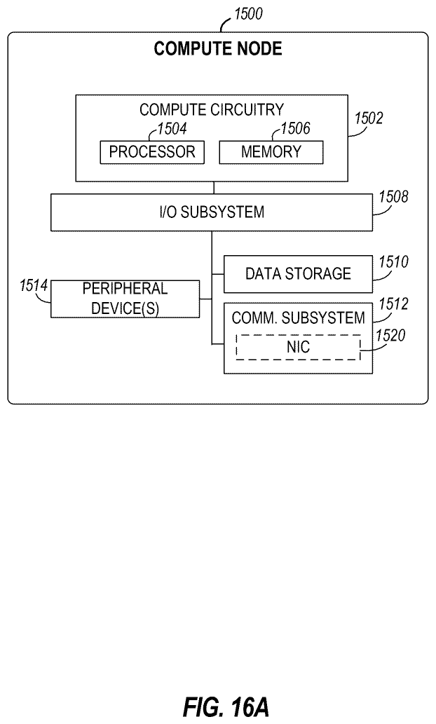

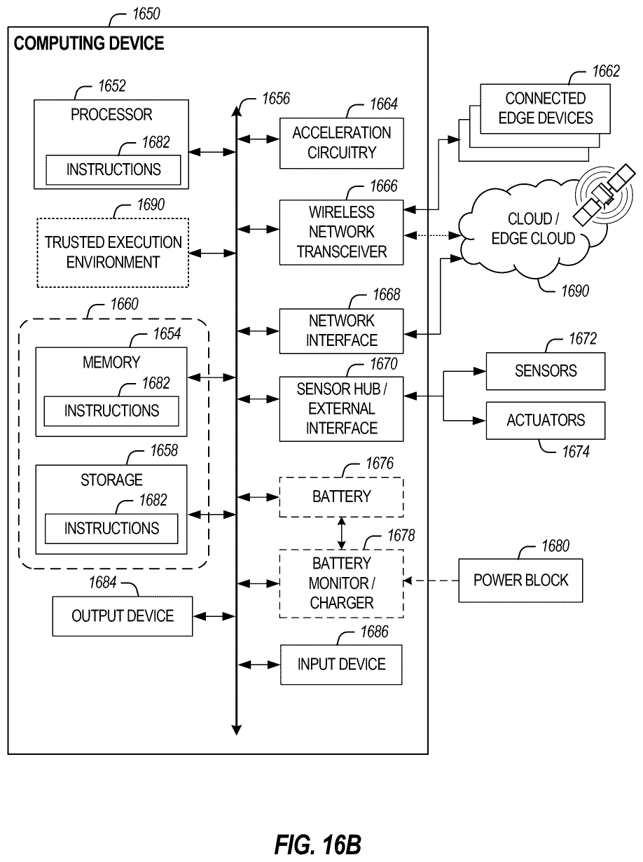

The network components of the edge cloud 1210 may be servers, multi-tenant servers, appliance computing devices, and/or any other type of computing devices. For example, a node of the edge cloud 1210 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 16B. The edge cloud 1210 may also include one or more servers and/or one or more multi-tenant servers. Such a server may include an operating system and implement a virtual computing environment. A virtual computing environment may include a hypervisor managing (e.g., spawning, deploying, shutting down, etc.) one or more virtual machines, one or more containers, etc. Such virtual computing environments provide an execution environment in which one or more applications and/or other software, code or scripts may execute while being isolated from one or more other applications, software, code or scripts.

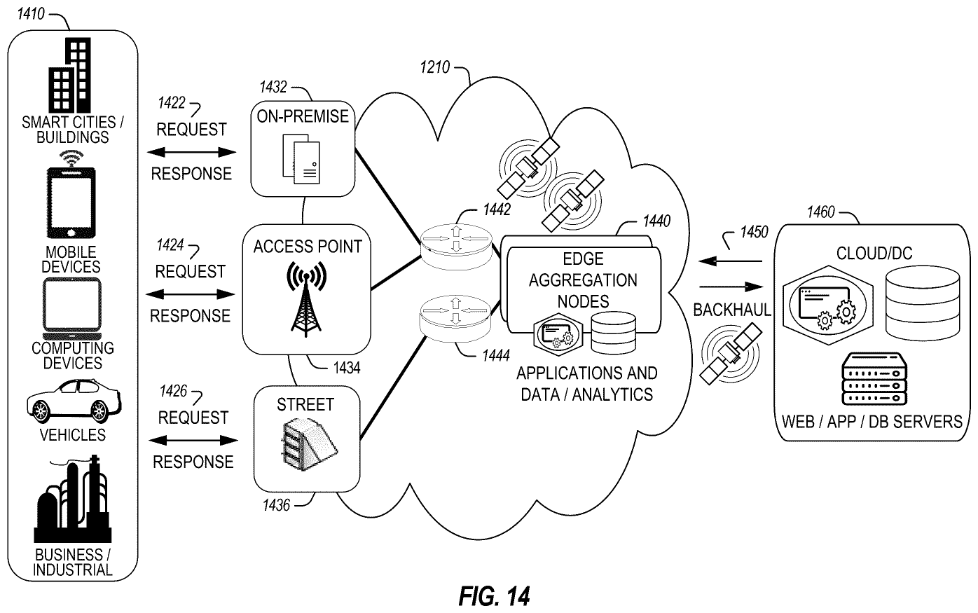

In FIG. 14, various client endpoints 1410 (in the form of mobile devices, computers, autonomous vehicles, business computing equipment, industrial processing equipment) exchange requests and responses that are specific to the type of endpoint network aggregation. For instance, client endpoints 1410 may obtain network access via a wired broadband network, by exchanging requests and responses 1422 through an on-premise network system 1432. Some client endpoints 1410, such as mobile computing devices, may obtain network access via a wireless broadband network, by exchanging requests and responses 1424 through an access point (e.g., cellular network tower) 1434. Some client endpoints 1410, such as autonomous vehicles may obtain network access for requests and responses 1426 via a wireless vehicular network through a street-located network system 1436. However, regardless of the type of network access, the TSP may deploy aggregation points 1442, 1444 within the edge cloud 1210 to aggregate traffic and requests. Thus, within the edge cloud 1210, the TSP may deploy various compute and storage resources, such as at edge aggregation nodes 1440 (including those located at satellite vehicles), to provide requested content. The edge aggregation nodes 1440 and other systems of the edge cloud 1210 are connected to a cloud or data center 1460, which uses a backhaul network 1450 (such as a satellite backhaul) to fulfill higher-latency requests from a cloud/data center for websites, applications, database servers, etc. Additional or consolidated instances of the edge aggregation nodes 1440 and the aggregation points 1442, 1444, including those deployed on a single server framework, may also be present within the edge cloud 1210 or other areas of the TSP infrastructure.

At a more generic level, an edge computing system may be described to encompass any number of deployments operating in the edge cloud 1210, which provide coordination from client and distributed computing devices. FIG. 13 provides a further abstracted overview of layers of distributed compute deployed among an edge computing environment for purposes of illustration.

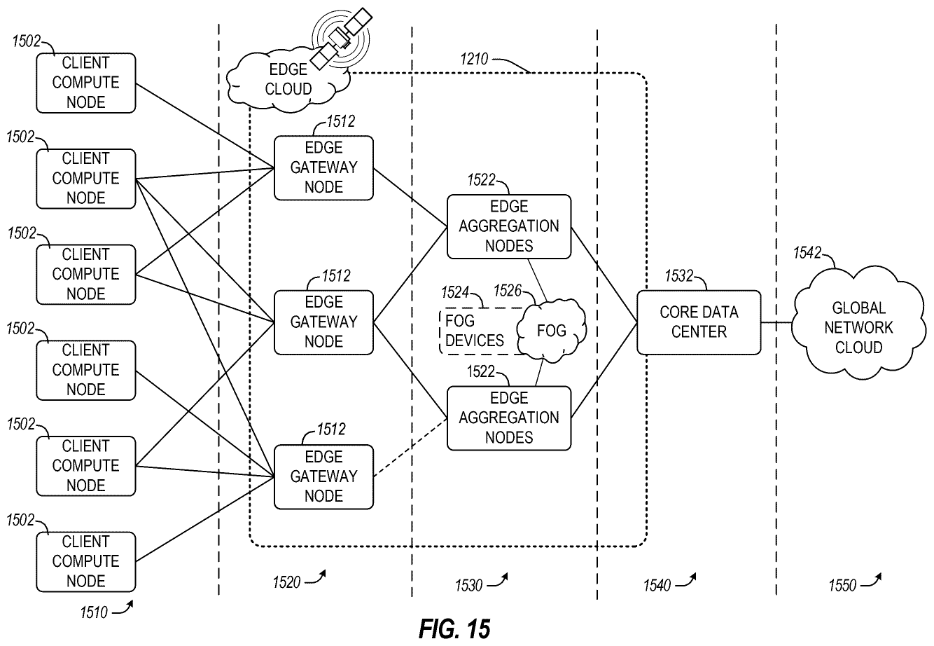

FIG. 15 generically depicts an edge computing system for providing edge services and applications to multi-stakeholder entities, as distributed among one or more client compute nodes 1502, one or more edge gateway nodes 1512, one or more edge aggregation nodes 1522, one or more core data centers 1532, and a global network cloud 1542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

A respective node or device of the edge computing system is located at a particular layer corresponding to layers 1300, 1310, 1320, 1330, 1340. For example, the client compute nodes 1502 are respectively located at an endpoint layer 1300, while the edge gateway nodes 1512 are respectively located at an edge devices layer 1310 (local level) of the edge computing system. Additionally, the edge aggregation nodes 1522 (and/or fog devices 1524, if arranged or operated with or among a fog networking configuration 1526) are located at a network access layer 1320 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 1532 is located at a core network layer 1330 (e.g., a regional or geographically-central level), while the global network cloud 1542 is located at a cloud data center layer 1340 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 1532 may be located within, at, or near the edge cloud 1210.

Although an illustrative number of client compute nodes 1502, edge gateway nodes 1512, edge aggregation nodes 1522, core data centers 1532, global network clouds 1542 are shown in FIG. 15, it should be appreciated that the edge computing system may include more or fewer devices or systems at a respective layer. Additionally, as shown in FIG. 15, the number of components of a respective layer 1300, 1310, 1320, 1330, 1340 generally increases at a lower level (e.g., when moving closer to endpoints). As such, one edge gateway node 1512 may service multiple client compute nodes 1502, and one edge aggregation node 1522 may service multiple edge gateway nodes 1512.

Consistent with the examples provided herein, a respective client compute node 1502 may be embodied as any type of end point component, device, appliance, or “thing” capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1210.

As such, the edge cloud 1210 is formed from network components and functional features operated by and within the edge gateway nodes 1512 and the edge aggregation nodes 1522 of layers 1320, 1330, respectively. The edge cloud 1210 may be embodied as any type of network that provides edge computing and/or storage resources which are proximately located to radio access network (RAN) capable endpoint devices (e.g., mobile computing devices, IoT devices, smart devices, etc.), which are shown in FIG. 13 as the client compute nodes 1502. In other words, the edge cloud 1210 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1210 may form a portion of or otherwise provide an ingress point into or across a fog networking configuration 1526 (e.g., a network of fog devices 1524, not shown in detail), which may be embodied as a system-level horizontal and distributed architecture that distributes resources and services to perform a specific function. For instance, a coordinated and distributed network of fog devices 1524 may perform computing, storage, control, or networking aspects in the context of an IoT system arrangement. Other networked, aggregated, and distributed functions may exist in the edge cloud 1210 between the cloud data center layer 1340 and the client endpoints (e.g., client compute nodes 1502). Some of these are discussed in the following sections in the context of network functions or service virtualization, including the use of virtual edges and virtual services which are orchestrated for multiple stakeholders.

The edge gateway nodes 1512 and the edge aggregation nodes 1522 cooperate to provide various edge services and security to the client compute nodes 1502. Furthermore, because a client compute node 1502 may be stationary or mobile, an edge gateway node 1512 may cooperate with other edge gateway devices to propagate presently provided edge services and security as the corresponding client compute node 1502 moves about a region. To do so, the edge gateway nodes 1512 and/or edge aggregation nodes 1522 may support multiple tenancy and multiple stakeholder configurations, in which services from (or hosted for) multiple service providers and multiple consumers may be supported and coordinated across a single or multiple compute devices.

In further examples, any of the compute nodes or devices discussed with reference to the present computing systems and environment may be fulfilled based on the components depicted in FIGS. 16A and 16B. A compute node may be embodied as a type of device, appliance, computer, or other “thing” capable of communicating with other edge, networking, or endpoint components.

In the simplified example depicted in FIG. 16A, an edge compute node 1600 includes a compute engine (also referred to herein as “compute circuitry”) 1602, an input/output (I/O) subsystem 1608, data storage device 1610, communication circuitry 1612, and, optionally, one or more peripheral devices 1614. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1600 may be embodied as any type of engine, device, or collection of devices capable of performing various compute functions. In some examples, the compute node 1600 may be embodied as a single device such as an integrated circuit, an embedded system, a field-programmable gate array (FPGA), a system-on-a-chip (SOC), or other integrated system or device. In the illustrative example, the compute node 1600 includes or is embodied as a processor 1604 and a memory 1606. The processor 1604 may be embodied as any type of processor capable of performing the functions described herein (e.g., executing an application). For example, the processor 1604 may be embodied as a multi-core processor(s), a microcontroller, or other processor or processing/controlling circuit. In some examples, the processor 1604 may be embodied as, include, or be coupled to an FPGA, an application specific integrated circuit (ASIC), reconfigurable hardware or hardware circuitry, or other specialized hardware to facilitate performance of the functions described herein.

The main memory 1606 may be embodied as any type of volatile (e.g., dynamic random access memory (DRAM), etc.) or non-volatile memory or data storage capable of performing the functions described herein. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory, other storage class memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1606 may be integrated into the processor 1604. The main memory 1606 may store various software and data used during operation such as one or more applications, data operated on by the application(s), libraries, and drivers.

The compute circuitry 1602 is communicatively coupled to other components of the compute node 1600 via the I/O subsystem 1608, which may be embodied as circuitry and/or components to facilitate input/output operations with the compute circuitry 1602 (e.g., with the processor 1604 and/or the main memory 1606) and other components of the compute circuitry 1602. For example, the I/O subsystem 1608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1608 may form a portion of a system-on-a-chip (SoC) and be incorporated, along with one or more of the processor 1604, the main memory 1606, and other components of the compute circuitry 1602, into the compute circuitry 1602.

The one or more illustrative data storage devices 1610 may be embodied as any type of devices configured for short-term or long-term storage of data such as, for example, memory devices and circuits, memory cards, hard disk drives, solid-state drives, or other data storage devices. A data storage device 1610 may include a system partition that stores data and firmware code for the data storage device 1610. A data storage device 1610 may also include one or more operating system partitions that store data files and executables for operating systems depending on, for example, the type of compute node 1600.

The communication circuitry 1612 may be embodied as any communication circuit, device, or collection thereof, capable of enabling communications over a network between the compute circuitry 1602 and another compute device (e.g., an edge gateway node 1512 of an edge computing system). The communication circuitry 1612 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 1612 includes a network interface controller (NIC) 1620, which may also be referred to as a host fabric interface (HFI). The NIC 1620 may be embodied as one or more add-in-boards, daughter cards, network interface cards, controller chips, chipsets, or other devices that may be used by the compute node 1600 to connect with another compute device (e.g., an edge gateway node 1512). In some examples, the NIC 1620 may be embodied as part of a system-on-a-chip (SoC) that includes one or more processors, or included on a multichip package that also contains one or more processors. In some examples, the NIC 1620 may include a local processor (not shown) and/or a local memory (not shown) that are both local to the NIC 1620. In such examples, the local processor of the NIC 1620 may be capable of performing one or more of the functions of the compute circuitry 1602 described herein. Additionally or alternatively, in such examples, the local memory of the NIC 1620 may be integrated into one or more components of the client compute node at the board level, socket level, chip level, and/or other levels.

Additionally, in some examples, a compute node 1600 may include one or more peripheral devices 1614. Such peripheral devices 1614 may include any type of peripheral device found in a compute device or server such as audio input devices, a display, other input/output devices, interface devices, and/or other peripheral devices, depending on the particular type of the compute node 1600. In further examples, the compute node 1600 may be embodied by a respective edge compute node in an edge computing system (e.g., client compute node 1502, edge gateway node 1512, edge aggregation node 1522) or like forms of appliances, computers, subsystems, circuitry, or other components.

In a more detailed example, FIG. 16B illustrates a block diagram of an example of components that may be present in an edge computing node 1650 for implementing the techniques (e.g., operations, processes, methods, and methodologies) described herein. The edge computing node 1650 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1650, or as components otherwise incorporated within a chassis of a larger system. Further, to support the security examples provided herein, a hardware ROT (e.g., provided according to a DICE architecture) may be implemented in an IP block of the edge computing node 1650 such that any IP Block may boot into a mode where a RoT identity may be generated that may attest its identity and its current booted firmware to another IP Block or to an external entity.

The edge computing node 1650 may include processing circuitry in the form of a processor 1652, which may be a microprocessor, a multi-core processor, a multithreaded processor, an ultra-low voltage processor, an embedded processor, or other known processing elements. The processor 1652 may be a part of a system on a chip (SoC) in which the processor 1652 and other components are formed into a single integrated circuit, or a single package, such as the Edison™ or Galileo™ SoC boards from Intel Corporation, Santa Clara, California. As an example, the processor 1652 may include an Intel® Architecture Core™ based processor, such as a Quark™, an Atom™, a Xeon™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1652 may communicate with a system memory 1654 over an interconnect 1656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1658 may also couple to the processor 1652 via the interconnect 1656. In an example, the storage 1658 may be implemented via a solid-state disk drive (SSDD). Other devices that may be used for the storage 1658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1658 may be on-die memory or registers associated with the processor 1652. However, in some examples, the storage 1658 may be implemented using a micro hard disk drive (HDD). Further, any number of new technologies may be used for the storage 1658 in addition to, or instead of, the technologies described, such resistance change memories, phase change memories, holographic memories, or chemical memories, among others.

The components may communicate over the interconnect 1656. The interconnect 1656 may include any number of technologies, including industry standard architecture (ISA), extended ISA (EISA), peripheral component interconnect (PCI), peripheral component interconnect extended (PCIx), PCI express (PCIe), NVLink, or any number of other technologies. The interconnect 1656 may be a proprietary bus, for example, used in an SoC based system. Other bus systems may be included, such as an I2C interface, an SPI interface, point to point interfaces, and a power bus, among others.

The interconnect 1656 may couple the processor 1652 to a transceiver 1666, for communications with the connected edge devices 1662. The transceiver 1666 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1662. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1666 (or multiple transceivers) may communicate using multiple standards or radios for communications at a different range. For example, the edge computing node 1650 may communicate with close devices, e.g., within about 10 meters, using a local transceiver based on BLE, or another low power radio, to save power. More distant connected edge devices 1662, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1666 (e.g., a radio transceiver) may be included to communicate with devices or services in the edge cloud 1690 via local or wide area network protocols. The wireless network transceiver 1666 may be an LPWA transceiver that follows the IEEE 802.15.4, or IEEE 802.15.4g standards, among others. The edge computing node 1650 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1666, as described herein. For example, the transceiver 1666 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1666 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1668 may be included to provide a wired communication to nodes of the edge cloud 1690 or to other devices, such as the connected edge devices 1662 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1668 may be included to enable connecting to a second network, for example, a first NIC 1668 providing communications to the cloud over Ethernet, and a second NIC 1668 providing communications to other devices over another type of network.

Given the variety of types of applicable communications from the device to another component or network, applicable communications circuitry used by the device may include or be embodied by any one or more of components provided by acceleration circuitry 1664, wireless network transceiver 1666, NIC 1668, or interface 1670. Accordingly, in various examples, applicable means for communicating (e.g., receiving, transmitting, etc.) may be embodied by such communications circuitry.

The edge computing node 1650 may include or be coupled to acceleration circuitry 1664, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1656 may couple the processor 1652 to a sensor hub or external interface 1670 that is used to connect additional devices or subsystems. The devices may include sensors 1672, such as accelerometers, level sensors, flow sensors, optical light sensors, camera sensors, temperature sensors, a global positioning system (GPS) sensors, pressure sensors, barometric pressure sensors, and the like. The hub or interface 1670 further may be used to connect the edge computing node 1650 to actuators 1674, such as power switches, valve actuators, an audible sound generator, a visual warning device, and the like.

In some optional examples, various input/output (I/O) devices may be present within or connected to, the edge computing node 1650. For example, a display or other output device 1684 may be included to show information, such as sensor readings or actuator position. An input device 1686, such as a touch screen or keypad may be included to accept input. An output device 1684 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1650.

A battery 1676 may power the edge computing node 1650, although, in examples in which the edge computing node 1650 is mounted in a fixed location, it may have a power supply coupled to an electrical grid. The battery 1676 may be a lithium ion battery, or a metal-air battery, such as a zinc-air battery, an aluminum-air battery, a lithium-air battery, and the like.

A battery monitor/charger 1678 may be included in the edge computing node 1650 to track the state of charge (SoCh) of the battery 1676. The battery monitor/charger 1678 may be used to monitor other parameters of the battery 1676 to provide failure predictions, such as the state of health (SoH) and the state of function (SoF) of the battery 1676. The battery monitor/charger 1678 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1678 may communicate the information on the battery 1676 to the processor 1652 over the interconnect 1656. The battery monitor/charger 1678 may also include an analog-to-digital (ADC) converter that enables the processor 1652 to directly monitor the voltage of the battery 1676 or the current flow from the battery 1676. The battery parameters may be used to determine actions that the edge computing node 1650 may perform, such as transmission frequency, mesh network operation, sensing frequency, and the like.

A power block 1680, or other power supply coupled to a grid, may be coupled with the battery monitor/charger 1678 to charge the battery 1676. In some examples, the power block 1680 may be replaced with a wireless power receiver to obtain the power wirelessly, for example, through a loop antenna in the edge computing node 1650. A wireless battery charging circuit, such as an LTC4020 chip from Linear Technologies of Milpitas, California, among others, may be included in the battery monitor/charger 1678. The specific charging circuits may be selected based on the size of the battery 1676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1658 may include instructions 1682 in the form of software, firmware, or hardware commands to implement the techniques described herein. Although such instructions 1682 are shown as code blocks included in the memory 1654 and the storage 1658, it may be understood that any of the code blocks may be replaced with hardwired circuits, for example, built into an application specific integrated circuit (ASIC).

In an example, the instructions 1682 provided via the memory 1654, the storage 1658, or the processor 1652 may be embodied as a non-transitory, machine-readable medium 1660 including code to direct the processor 1652 to perform electronic operations in the edge computing node 1650. The processor 1652 may access the non-transitory, machine-readable medium 1660 over the interconnect 1656. For instance, the non-transitory, machine-readable medium 1660 may be embodied by devices described for the storage 1658 or may include specific storage units such as optical disks, flash drives, or any number of other hardware devices. The non-transitory, machine-readable medium 1660 may include instructions to direct the processor 1652 to perform a specific sequence or flow of actions, for example, as described with respect to the flowchart(s) and block diagram(s) of operations and functionality depicted above. As used in, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 16A and 16B are intended to depict a high-level view of components of a device, subsystem, or arrangement of an edge computing node. However, it will be understood that some of the components shown may be omitted, additional components may be present, and a different arrangement of the components shown may occur in other implementations.

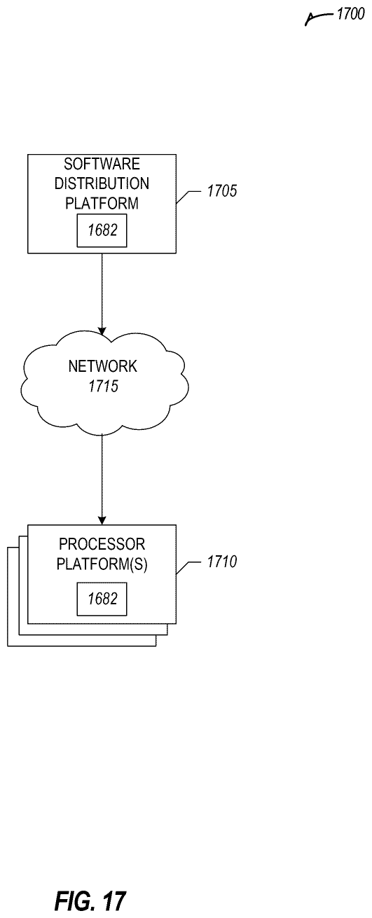

FIG. 17 illustrates an example software distribution platform 1705 to distribute software, such as the example computer readable instructions 1682 of FIG. 16B, to one or more devices, such as example processor platform(s) 1710 and/or other example connected edge devices or systems discussed herein. The example software distribution platform 1705 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1705). Example connected edge devices may operate in commercial and/or home automation environments. In some examples, a third party is a developer, a seller, and/or a licensor of software such as the example computer readable instructions 1682 of FIG. 16B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 17, the software distribution platform 1705 includes one or more servers and one or more storage devices that store the computer readable instructions 1682. The one or more servers of the example software distribution platform 1705 are in communication with a network 1715, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1682 from the software distribution platform 1705. For example, the software, which may correspond to example computer readable instructions, may be downloaded to the example processor platform(s), which is/are to execute the computer readable instructions 1682. In some examples, one or more servers of the software distribution platform 1705 are communicatively connected to one or more security domains and/or security devices through which requests and transmissions of the example computer readable instructions 1682 must pass. In some examples, one or more servers of the software distribution platform 1705 periodically offer, transmit, and/or force updates to the software (e.g., the example computer readable instructions 1682 of FIG. 16B) to ensure improvements, patches, updates, etc. are distributed and applied to the software at the end user devices.

In the illustrated example of FIG. 17, the computer readable instructions 1682 are stored on storage devices of the software distribution platform 1705 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1682 stored in the software distribution platform 1705 are in a first format when transmitted to the example processor platform(s) 1710. In some examples, the first format is an executable binary in which particular types of the processor platform(s) 1710 can execute. However, in some examples, the first format is uncompiled code that requires one or more preparation tasks to transform the first format to a second format to enable execution on the example processor platform(s) 1710. For instance, the receiving processor platform(s) 1700 may need to compile the computer readable instructions 1682 in the first format to generate executable code in a second format that is capable of being executed on the processor platform(s) 1710. In still other examples, the first format is interpreted code that, upon reaching the processor platform(s) 1710, is interpreted by an interpreter to facilitate execution of instructions.

### Example Implementation Systems and Methods

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is at least one non-transitory machine-readable medium comprising instructions, wherein the instructions, when executed by processing circuitry of a computing system, cause the processing circuitry to perform operations that: establish, via communication circuitry of the computing system, a wireless backhaul connection to communicate data between an IAB Donor and an IAB Node, the wireless backhaul connection to provide multiple channels including a dedicated backhaul channel, a control channel, and a data channel; perform channel sounding, via the control channel, to exchange reference signals that provide feedback for a state of the wireless backhaul connection; evaluate results from the channel sounding with a trained artificial intelligence (AI) model, the trained AI model to output at least one identified change to the wireless backhaul connection; and adaptively modify at least one characteristic of the wireless backhaul connection, based on the at least one identified change.

In Example 2, the subject matter of Example 1 optionally includes wherein the at least one identified change to the wireless backhaul connection is to change (e.g., changes) a bandwidth or a priority of the dedicated backhaul channel.

In Example 3, the subject matter of any one or more of Examples 1-2 optionally include wherein the results from the channel sounding are to indicate interference that occurs on the wireless backhaul connection, and wherein the trained AI model is to output (e.g., outputs) the at least one identified change to reduce the interference.

In Example 4, the subject matter of any one or more of Examples 1-3 optionally include wherein the channel sounding is to be performed based on a downlink from the IAB Donor to the IAB Node, and wherein the channel sounding is based on a channel state information reference signal (CSI-RS) provided to the IAB Node via the downlink.

In Example 5, the subject matter of Example 4 optionally includes wherein the trained AI model is to determine (e.g., determines) a beamforming pattern to include within a channel state information (CSI) report, and wherein the CSI report is to be provided from the IAB Node to the IAB Donor in response to the CSI-RS.

In Example 6, the subject matter of any one or more of Examples 1-5 optionally include wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.

In Example 7, the subject matter of Example 6 optionally includes wherein the trained AI model is to use (e.g., uses) information from the SRS to determine a beamforming pattern and an optimization for the dedicated backhaul channel.

In Example 8, the subject matter of any one or more of Examples 1-7 optionally include wherein the dedicated backhaul channel is to exchange (e.g., exchanges and communicates) inferencing data and inferencing results between the IAB Node and the IAB Donor based on processing capabilities at the IAB Node or the IAB Donor, the inferencing data including information from at least one sensor at the IAB Node, and the inferencing results including information from an execution of at least one AI model at the IAB Donor.

In Example 9, the subject matter of any one or more of Examples 1-8 optionally include wherein the wireless backhaul connection is to be established based on an initial backhaul policy, and wherein the initial backhaul policy is to be updated based on the at least one identified change.

Example 10 is a computing device, comprising: communication circuitry; processing circuitry; and at least one machine-readable medium including instructions embodied thereon, wherein the instructions, when executed by the processing circuitry, configure the processing circuitry to cause operations that: establish, via the communication circuitry, a wireless backhaul connection to communicate data between an IAB Donor and an IAB Node, the wireless backhaul connection to provide multiple channels, including a dedicated backhaul channel, a control channel, and a data channel; perform channel sounding, via the control channel, to exchange reference signals that provide feedback for a state of the wireless backhaul connection; evaluate results from the channel sounding with a trained artificial intelligence (AI) model, the trained AI model to output at least one identified change to the wireless backhaul connection; and adaptively modify at least one characteristic of the wireless backhaul connection, based on the at least one identified change.

In Example 11, the subject matter of Example 10 optionally includes wherein the at least one identified change to the wireless backhaul connection is to change (e.g., changes) a bandwidth or a priority of the dedicated backhaul channel.

In Example 12, the subject matter of any one or more of Examples 10-11 optionally include wherein the results from the channel sounding are to indicate interference that occurs on the wireless backhaul connection, and wherein the trained AI model is to output (e.g., outputs, provides, etc.) the at least one identified change to reduce the interference.

In Example 13, the subject matter of any one or more of Examples 10-12 optionally include wherein the channel sounding is to be performed based on a downlink from the IAB Donor to the IAB Node, and wherein the channel sounding is based on a channel state information reference signal (CSI-RS) provided to the IAB Node via the downlink.

In Example 14, the subject matter of any one or more of Examples 10-13 optionally include wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.

In Example 15, the subject matter of any one or more of Examples 10-14 optionally include wherein the dedicated backhaul channel is to exchange (e.g., communicates, exchanges, etc.) inferencing data and inferencing results between the IAB Node and the IAB Donor based on processing capabilities at the IAB Node or the IAB Donor, the inferencing data including information from at least one sensor at the IAB Node, and the inferencing results including information from an execution of at least one AI model at the IAB Donor.

Example 16 is a method of operating an adaptive backhaul channel in an integrated access backhaul (IAB) deployment, the method comprising: establishing a wireless backhaul connection to communicate data between an IAB Donor and an IAB Node, the wireless backhaul connection to provide multiple channels including a dedicated backhaul channel, a control channel, and a data channel; performing channel sounding, via the control channel, to exchange reference signals that provide feedback for a state of the wireless backhaul connection; evaluating results from the channel sounding with a trained artificial intelligence (AI) model, the trained AI model to output at least one identified change to the wireless backhaul connection; and updating at least one characteristic of the wireless backhaul connection, based on the at least one identified change.

In Example 17, the subject matter of Example 16 optionally includes wherein the at least one identified change to the wireless backhaul connection is to cause (e.g., causes) a change to a bandwidth or a priority of the dedicated backhaul channel.

In Example 18, the subject matter of any one or more of Examples 16-17 optionally include wherein the results from the channel sounding are to indicate interference that occurs on the wireless backhaul connection, and wherein the trained AI model is to output (e.g., outputs, provides, etc.) the at least one identified change to reduce the interference.

In Example 19, the subject matter of any one or more of Examples 16-18 optionally include wherein the channel sounding is to be performed based on a downlink from the IAB Donor to the IAB Node, and wherein the channel sounding is based on a channel state information reference signal (CSI-RS) provided to the IAB Node via the downlink.

In Example 20, the subject matter of any one or more of Examples 16-19 optionally include wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.

Example 21 is a device, comprising: processing circuitry; and a memory device including instructions embodied thereon, wherein the instructions, which when executed by the processing circuitry, configure the processing circuitry to perform operations for Integrated Access Backhaul (IAB) of a 5G network, with use of Artificial Intelligence model data processing, in accordance with Examples 1-20 and the techniques discussed herein.

Example 22 is a method, comprising a plurality of operations executed with a processor and memory of a device, to perform operations for Integrated Access Backhaul (IAB) of a 5G network, with use of Artificial Intelligence model data processing, in accordance with Examples 1-20 and the techniques discussed herein.

Example 23 is a non-transitory device-readable storage medium including instructions, wherein the instructions, when executed by a processing circuitry of a device, cause the processing circuitry to perform operations for Integrated Access Backhaul (IAB) of a 5G network, with use of Artificial Intelligence model data processing, in accordance with Examples 1-20 and the techniques discussed herein.

Example 24 is an apparatus, comprising respective means for Integrated Access Backhaul (IAB) of a 5G network, with use of Artificial Intelligence model data processing, in accordance with Examples 1-20 and the techniques discussed herein.

Example 25 is a network equipment comprising circuitry for enabling Integrated Access Backhaul (IAB) of a 5G network, with use of Artificial Intelligence model data processing, in accordance with Examples 1-20 and the techniques discussed herein.

Example 26 is a 5G communication network, comprising network equipment configured for Integrated Access Backhaul (IAB) of a 5G network, with use of Artificial Intelligence model data processing, in accordance with Examples 1-20 and the techniques discussed herein.

Example 27 is a network comprising respective devices and device communication mediums for performing Examples 1-20 and any of the operations or techniques discussed herein.

Example 28 is a system comprising respective components arranged or configured to perform Examples 1-20 and any of the operations or techniques discussed herein.

Example 29 is a method, performed using circuitry of a computing device, arranged or configured to perform Examples 1-20 and any of the operations or techniques discussed herein.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve different network connectivity paths (where available) to increase network bandwidth/throughput and to support additional network services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. Combinations of the above aspects will be apparent to those of skill in the art upon reviewing the above description.

What is claimed is:

1. At least one non-transitory machine-readable medium comprising instructions, wherein the instructions, when executed by processing circuitry of a computing system, cause the processing circuitry to perform operations that:
establish, via communication circuitry of the computing system, a wireless backhaul connection to communicate data between an Integrated Access Backhaul (IAB) Donor and an IAB Node, the wireless backhaul connection to provide multiple channels including a dedicated backhaul channel, a control channel, and a data channel;
perform channel sounding, via the control channel, to exchange reference signals that provide feedback for a state of the wireless backhaul connection;
evaluate results from the channel sounding with a trained artificial intelligence (AI) model, the trained AI model to output at least one identified change to the wireless backhaul connection; and
adaptively modify at least one characteristic of the wireless backhaul connection, based on the at least one identified change.

2. The at least one non-transitory machine-readable medium of claim 1, wherein the at least one identified change to the wireless backhaul connection is to change a bandwidth or a priority of the dedicated backhaul channel.

3. The at least one non-transitory machine-readable medium of claim 1, wherein the results from the channel sounding are to indicate interference that occurs on the wireless backhaul connection, and wherein the trained AI model is to output the at least one identified change to reduce the interference.

4. The at least one non-transitory machine-readable medium of claim 1, wherein the channel sounding is to be performed based on a downlink from the IAB Donor to the IAB Node, and wherein the channel sounding is based on a channel state information reference signal (CSI-RS) provided to the IAB Node via the downlink.

5. The at least one non-transitory machine-readable medium of claim 4, wherein the trained AI model is to determine a beamforming pattern to include within a channel state information (CSI) report, and wherein the CSI report is to be provided from the IAB Node to the IAB Donor in response to the CSI-RS.

6. The at least one non-transitory machine-readable medium of claim 1, wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.

7. The at least one non-transitory machine-readable medium of claim 6, wherein the trained AI model is to use information from the SRS to determine a beamforming pattern and an optimization for the dedicated backhaul channel.

8. The at least one non-transitory machine-readable medium of claim 1, wherein the dedicated backhaul channel is to exchange inferencing data and inferencing results between the IAB Node and the IAB Donor based on processing capabilities at the IAB Node or the IAB Donor, the inferencing data including information from at least one sensor at the IAB Node, and the inferencing results including information from an execution of at least one AI model at the IAB Donor.

9. The at least one non-transitory machine-readable medium of claim 1, wherein the wireless backhaul connection is to be established based on an initial backhaul policy, and wherein the initial backhaul policy is to be updated based on the at least one identified change.

10. A computing device, comprising:
communication circuitry;
processing circuitry; and
at least one machine-readable medium including instructions embodied thereon, wherein the instructions, when executed by the processing circuitry, configure the processing circuitry to cause operations that:
establish, via the communication circuitry, a wireless backhaul connection to communicate data between an Integrated Access Backhaul (IAB) Donor and an IAB Node, the wireless backhaul connection to provide multiple channels, including a dedicated backhaul channel, a control channel, and a data channel;
perform channel sounding, via the control channel, to exchange reference signals that provide feedback for a state of the wireless backhaul connection;
evaluate results from the channel sounding with a trained artificial intelligence (AI) model, the trained AI model to output at least one identified change to the wireless backhaul connection; and
adaptively modify at least one characteristic of the wireless backhaul connection, based on the at least one identified change.

11. The computing device of claim 10, wherein the at least one identified change to the wireless backhaul connection is to change a bandwidth or a priority of the dedicated backhaul channel.

12. The computing device of claim 10, wherein the results from the channel sounding are to indicate interference that occurs on the wireless backhaul connection, and wherein the trained AI model is to output the at least one identified change to reduce the interference.

13. The computing device of claim 10, wherein the channel sounding is to be performed based on a downlink from the IAB Donor to the IAB Node, and wherein the channel sounding is based on a channel state information reference signal (CSI-RS) provided to the IAB Node via the downlink.

14. The computing device of claim 10, wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.

15. The computing device of claim 10, wherein the dedicated backhaul channel is to exchange inferencing data and inferencing results between the IAB Node and the IAB Donor, the inferencing data including information from at least one sensor at the IAB Node, and the inferencing results including information from an execution of at least one AI model at the IAB Donor.

16. A method of operating an adaptive backhaul channel in an integrated access backhaul (IAB) deployment, the method comprising:
establishing a wireless backhaul connection to communicate data between an IAB Donor and an IAB Node, the wireless backhaul connection to provide multiple channels including a dedicated backhaul channel, a control channel, and a data channel;
performing channel sounding, via the control channel, to exchange reference signals that provide feedback for a state of the wireless backhaul connection;
evaluating results from the channel sounding with a trained artificial intelligence (AI) model, the trained AI model to output at least one identified change to the wireless backhaul connection; and
updating at least one characteristic of the wireless backhaul connection, based on the at least one identified change.

17. The method of claim 16, wherein the at least one identified change to the wireless backhaul connection is to cause a change to a bandwidth or a priority of the dedicated backhaul channel.

18. The method of claim 16, wherein the results from the channel sounding are to indicate interference that occurs on the wireless backhaul connection, and wherein the trained AI model is to output the at least one identified change to reduce the interference.

19. The method of claim 16, wherein the channel sounding is to be performed based on a downlink from the IAB Donor to the IAB Node, and wherein the channel sounding is based on a channel state information reference signal (CSI-RS) provided to the IAB Node via the downlink.

20. The method of claim 16, wherein the channel sounding is to be performed based on an uplink of the wireless backhaul connection from the IAB Node to the IAB Donor, and wherein the channel sounding includes use of a sounding reference signal (SRS) provided from the IAB Node to the IAB Donor via the uplink.
